(19) United States
(12) Patent Application Publication
(10) Pub. No.: US 2017/0276488 A1
(43) Pub. Date: Sep. 28, 2017

(54) NAVIGATED URBAN FLOATING OFFICE OR RESIDENTIAL STRUCTURE FOR INDEPENDENT PARTIES

(71) Applicant: Gregory AHARONIAN, Belmont, MA (US)

(72) Inventor: Gregory AHARONIAN, Belmont, MA (US)

(21) Appl. No.: 15/621,620

(22) Filed: Jun. 13, 2017

Related U.S. Application Data
(63) Continuation of application No. 15/076,281, filed on Mar. 21, 2016, now abandoned.
Application No. 15/076,281 is a continuation of application No. 13/814,194, filed on Feb. 4, 2013, now abandoned.
(60) Provisional application No. 61/387,835, filed on Sep. 29, 2010.

(51) Int. Cl. G01C 21/20; B63B 35/00; B63B 35/44; B63B 35/54; B63H 21/21; B63H 25/04; B63J 99/00

(52) U.S. Cl. CPC G01C 21/203; B63B 35/54; B63B 35/44; B63B 35/00; B63H 25/04; B63H 2021/216; B63J 2099/006; B63B 2213/00

(57) ABSTRACT

Structures, systems and methods are disclosed for navigating a vessel, typically through the waterways of a single urban region (e.g., San Francisco Bay), that can be used as a floating structure for residences or offices, for independent parties. Also disclosed are structures, systems and methods for navigating such a vessel that minimize energy use while satisfying the logistical needs of parties using the vessel, as well as satisfying laws that restrict the movement and location of navigable structures. Also disclosed are structures, systems and methods for navigating such a vessel that satisfy laws that regulate the environmental impact of a such vessel, and that ensures the safety and health of people using this vessel.

### 1. CROSS-REFERENCE TO RELATED APPLICATIONS

This application is a continuation application of U.S. patent application Ser. No. 15/076,281, filed on Mar. 21, 2016, which is a continuation application of U.S. patent application Ser. No. 13/814,194, filed on Feb. 4, 2013 (with an International Filing Date of Sep. 28, 2011), which is a National Phase application under 35 U.S.C. §371 of International Application PCT/US2011/053721, with an International Filing Date of Sep. 28, 2011, which claims priority to provisional U.S. Patent Application Ser. No. 61/387,835, filed Sep. 29, 2010, the entire disclosures of which are herein incorporated by reference in their entirety and for all purposes.

### 2. NOTICE OF COPYRIGHT

Parts of this patent application include materials that are subject to copyright protection. The owner of the copyrights has no objection to the facsimile reproduction by anyone of the patent document itself, or of the patent application, as it appears in the files of the United States Patent and Trademark Office, but otherwise reserves all rights whatsoever in such included materials protected by copyright.

### 3. BACKGROUND

### 3.1 Technical Field

The technical field of invention comprises the intersection of the technical fields of: static structures (e.g., buildings) [USPTO Class 52, IPC8 Class E04], ships or other waterborne vessels [USPTO Class 114, IPC8 Class B63], and navigation [USPTO Classes 701/200:226, IPC8 Classes G01C 21/00:36].

Industrial Applicability: The present invention is useful in providing new methods and systems for manufacturing opportunities relating to office and residential structures in urban areas.

### 3.2 Centuries of Living in the City or Living on the Sea

For centuries, the allure and usefulness of life in the big city continues to increase. The mix of cultures, entertainment, education, business, living, dining, transportation, political and other opportunities makes cities such as San Francisco, Los Angeles, New York, Lisbon, Cartegena, Rio de Janeiro, Hong Kong, Shanghai and Sydney the large, exciting, thriving urban environments that continue to attract new residents.

As well for centuries, people have been drawn to life at sea. Call it a primal urge drawn from our evolutionary origins in the sea to migrations along the coasts. Call it a desire for the different—the stability of land exchanged for the dynamics of water. From ocean explorers to ocean traders to ocean living (seasteading), many are drawn to water beyond a swim at the beach, or driving along California's Pacific Coast Highway, Costa Rica's Costanera, Australia's Great Ocean Road, or Spain's Costa Del Sol.

It is very surprising then, that over the centuries, there has been a failure to truly combine both experiences—living on the waters by the city. The yalis of Istanbul, houses with one side directly adjacent to the water, e.g., are as close as you can get from the land side, the next step being to moor residences immediately offshore, e.g., houseboats, junks and boatels. But here evolution has mostly stopped due to multiple technological problems others have failed to solve.

### 3.3 Defects and Inadequacies: Houseboat/Oceanboat/Riverboat Living

A popular form of living nearest to the waterways of an urban region is traditional single occupancy/family houseboats which are moored/secured to land (especially for vital connections for power/water/sewage), as seen, for example, in houseboat communities that are located in the shallow waters of San Francisco and Seattle bays, and moored junk communities (one family fishing vessels) of Aberdeen Harbour in Hong Kong, and moored oddities such as the 1850s floating church in Philadelphia, or the Tai Pak Floating Restaurant moored in Aberdeen Harbour.

Many patents have issued for new designs of houseboats, for example, from U.S. Pat. No. 3,581,692 to U.S. Patent Application 2007/056498. A few patents have been issued for related forms of urban moored floating living, including JP2003591 and WO99/20521 (moored, ship-like structures used as residences), and FR2599706 and GB1297245 (moored floating hotels). Non-patent examples for moored lifestyles include new designs for houseboats from Erikstad Architecture, the moored barge for artists in New York City (the WaterPod); an analysis of moored barges for apartments in a Swedish university thesis, “Apartment barges—a comfort and safety analysis”, the Edge (a thesis studying moored floating neighborhoods for the city of Richmond in British Columbia); the moored Elizabeth River Learning Barge; and the moored floating camp River of Trees in the Atchafayala basin. Such moored structures pose few, if any, navigation problems that are found in urban waterways, because of their nearly constant physical connections to the shore/pier/land.

At the great expense of abandoning daily life in an urban region, are non-urban vessels travelling the oceans. Examples include U.S. Pat. No. 4,732,103, a barge converted into an offshore residential structure; the massive, globally-navigated floating pseudo-cities such as the Freedom Ship (www.freedomship.com) and the Residential Ocean Liners (www.residentialvessels.com), and aircraft carriers. Not only is regular living in a single urban region prohibited with such vessels, but also some of these vessels (and their predecessors, cruise ships) have hull depths (e.g., 25 to 40 feet) that prevent them from being navigated in most parts of the waterways of an urban region. Such vessels, which consume large amounts of fuel, have few navigation problems, if any, in the waterways of an urban region, with the exception of moving to/from a pier for a short-term visit, similar to cargo container ships.

Also at the great expense of abandoning daily life in a single urban region, are non-urban temporary housing floating on rivers. Examples include U.S. Pat. No. 3,964,418 (a large campground on a barge that carries recreational vehicles between cities on a river); the yet-to-be-funded River Cities Condos project, a huge barge structure for condominiums that travels between cities of the flood-prone Mississippi River (www.rivercitiescondos.com); and a variety of river-based floating hotels such as the Boatel Houseboat on the Murray River in Australia. River-based floating housing has a simple, one-dimensional, non-intersecting navigation problem when not moored—avoid hitting the vessels fore and aft, and then only for river regions with a great density of traffic (most river-based floating housing/hotels travel in regions or rivers that are far from any urban area).

### 3.6 Problems to be Resolved

For more than 40 years, others have failed to teach a solution to the problem of navigating a floating structure for residences and/or offices within the waterways of an urban region, for a plurality of hours a day for most days of the year, where multiple technical problems need to be solved, such as the daily intermodal transportation needs of multiple independent parties/families who occupy the structure, and the problems of satisfying the navigation and health laws of multiple federal, state and local agencies. For more than 40 years, others have failed to make use of anchorage areas within the waterways of an urban region to help solve such problems.

For more than 40 years, others have failed to teach how to solve to the logistic problems of supplying occupants of this type of navigated structure with consumables and arranging intermodal transportation (e.g., from a structure to a transit system), etc., while supplying the energy for navigating the structure for a plurality of hours of the day for many days of the year.

For more than 40 years, others have failed to offer for sale any type of high-priced residential properties that are located on a vessel used as a floating structure for residences or offices for independent parties that is navigated throughout the waterways of a single urban region. For over 40 years, others have failed to motivate developers of real estate to research, develop, manufacture and sell residences and offices based on the structures, systems and methods that are disclosed herein, especially in lucrative real estate markets such as San Francisco, Seattle, Rio de Janeiro, Sydney, Lisbon and Hong Kong.

One reason for the failure of others to so innovate is the sheer complexity of navigational and logistical problems that arise in the waterways of a single urban region. In sharp contrast to the one-dimensional navigation of rivers (upstream, downstream), are urban waterways that pose two-dimensional navigation problems, with multiple forms of crisscrossing traffic that can be daily, weekly and/or monthly (e.g., container ships, recreational vessels, day ferries, sailboats, etc.),

These more complex navigation problems create unsolved expensive problems of energy supply minimization that arise from navigating a residence or office structure through the waterways of an urban region for a plurality of hours a day for many days of the year.

All of these technical problems are further complicated by the random ship-to-shore navigation requirements of residents (e.g., going to work, leisure activities, emergencies, etc.), as opposed to the controlled flow, e.g., of guests of cruise ships.

### 4. SUMMARY

In a first aspect, described herein is a residential or office structure for independent parties, including a first vessel capable of navigating the waterways of a single urban region. Additionally, the structure includes at least one navigation system that controls the movement of the first vessel along at least one route through the waterways of a single urban region. Additionally, the structure includes at least one energy management system for determining at least one navigational route for use by said navigation system to move said first vessel for a plurality of hours for any of the days of the year in which said first vessel is moved, with, for example, said route including coordinates of at least one anchorage area.

### 5. BRIEF DESCRIPTION OF THE DRAWINGS

Exemplary embodiments of the invention will be better understood by making reference to the following detailed description of the attached drawings, in which FIGS. 1 to 14 represent:

FIG. 1 is a map of part of the San Francisco Bay region.

FIGS. 2 and 3 are exemplary lists of other urban regions with waterways.

FIG. 4 is a generalized diagram of the San Francisco Bay region.

FIG. 5 is a template version of the diagram of FIG. 4.

FIG. 6 is a diagram illustrating two daily navigable routes for a NUFORS.

FIG. 7 is a diagram illustrating a longer, more scenic, navigable route for a NUFORS.

FIG. 8 is a diagram illustrating some of the General Anchorage areas of San Francisco Bay, while FIG. 9 is a diagram illustrating a region of Regulated Navigation Areas of San Francisco Bay.

FIG. 10 is a diagram illustrating a daily navigational route for a NUFORS.

FIG. 11 is a diagram illustrating a daily navigational route for a NUFORS.

FIG. 12 is a diagram illustrating variances in daily routes for a NUFORS.

FIG. 13 is a diagram illustrating a daily navigational route for a NUFORS.

FIG. 14 contains examples of anchorage information.

FIG. 15 is a diagram illustrating an exemplary NUFORS relative to an anchorage area of a body of water.

FIG. 16 is a diagram illustrating an exemplary navigational system for a NUFORS.

In the following description, reference is made to the accompanying diagrams which illustrate several embodiments of the invention. It is understood that other embodiments may be utilized, and that mechanical, compositional, structural, electrical, and operational modifications may be made without departing from the spirit and scope of the present disclosure. The following detailed description is not to be understood in a limiting sense.

### 6. DETAILED DESCRIPTION OF THE INVENTION

### 6.0 Index to Section 6

Section 6 of the Detailed Description is divided into 7 parts: 6.1—Definitions; 6.2—Exemplary Urban Regions; 6.3—Exemplary Vessels; 6.4—Exemplary Residences or Offices; 6.5—Exemplary Energy Management Systems, Methods and Economics; 6.6—Exemplary Navigational Systems and Methods; and 6.7 Other Exemplary Aspects.

### 6.1 Definitions

The terms “resident” and “occupant” used herein typically refer to a person substantially, and continually, using either a residential structure or an office structure, typically with the person being a (partial) owner, an employee, or a renter, of the residence or office. An office structure can be used, for example, for administrative, marketing, client support and/or vending purposes.

The phrase “independent parties” used herein typically refers to two or more independent groups of related people with partially disjoint requirements for navigation, intermodal transport, and logistical needs, when using and occupying their shared residential vessel. For example, a floating residence can comprise at least two groups of residents: the first group can be a family of four people (two parents and two children), while the second group can be a single person, an unmarried couple, or two roommates (with similar inter- and intra-relationships as if they lived in an apartment building on land). Each group typically makes collective decisions as to their navigational and transport needs, but these needs are not necessarily equivalent for the two groups. Satisfying both sets of needs can require compromise that can be coordinated by the vessel's pilot and/or navigational system. In another example, a floating office structure can comprise at least two groups of one or more occupants who work for different corporations, or at least two groups of one or more occupants within one corporate structure.

The terms “waterway” or “waterways” used herein typically refer to any navigable body of water, including rivers, lakes, bays, estuaries (bays with significant fresh water flows), seas, oceans and canals. Typically, to be navigable, a waterway must meet several criteria, including: being deep and wide enough for the vessels using it to be navigated through, being free of navigation barriers, and with average currents mild enough to allow the vessels to be navigated through with or without being propelled. One example of a waterway is a bay adjacent to at least one city, such as San Francisco Bay, Baia de Guanabara or Tokyo-wan. Bodies of water in an urban region are referred herein as either “waterway” or “waterways”. For example, the entire body of water in San Francisco Bay can be referred to as comprising one waterway, or comprising two waterways: San Francisco Bay and San Pablo Bay (arbitrarily delimited by the Richmond bridge), or these two main waterways plus the smaller bays—San Rafael, Richardson, Grizzly/Suisun/Honker and San Leandro (now mostly a marsh). Regardless of such labels, the references are to one contiguous body of water for vessels to navigate in.

In the United States, the Department of Homeland Security is responsible for the general regulation of navigation on American waterways. Such regulations, and more information, are available at: www.navcen.uscg.gov/mwv/navrules/rotr_online.htm as of September 2009.

The acronym “NUFORS” (“Navigated Urban Floating Office Residence Structure”) used herein typically refers to a vessel used as a residential, or office, structure occupied by independent parties, that is navigated in the waterways of an urban region, wherein said vessel is navigated while satisfying one or more governmental regulations on navigation, housing, health and environmental protection.

The term “tender” used herein typically refers to a vessel or a vehicle generally used to transport people and/or supplies to and from a NUFORS and another NUFORS, or to and from a land-based portal. Typically, a tender is smaller than an NUFORS, e.g., a powerboat. In regions where there are more than one NUFORS, one or more tenders can be shared between the NUFORSes. For a sufficiently large NUFORS, a small helicopter can be used as a tender. A tender can have its base of operations onshore (for example, a company that operates a shuttle service for one or more NUFORSes using one or more tenders, similar to tug boat services offered in many ports), or the tender can have its base of operations on a NUFORS. While most tenders are powered, occupants of a NUFORS can also use self-propelled vessels (e.g., a kayak) to connect to land-based portals. Ambitious residents can simply jump off the vessel and swim to shore.

6.2 Exemplary Urban Regions with Waterways

The terms “single urban region” and “urban region” used herein typically refer to a region with at least one navigable waterway, a waterway that typically can be characterized as being located adjacent to at least one city; and/or where the waterway can be adjacent to an ocean; and/or where the waterway can be substantially isolated from an adjacent ocean by natural or artificial barriers; and/or where the waterway can provide sufficient space for two-dimensional navigational routes; and/or where the infrastructure in the surrounding urban environment can provide a variety of social, medical, educational, occupational, entertainment, transportation, telecommunications, and energy opportunities, and other resources.

Typically, an urban region has natural or artificial structures that provide some/much protection from ocean-driven storms for vessels on the waterway. For example, the hills of the city of San Francisco (such as Twin Peaks) and of the Golden Gate National Recreational Area in Marin naturally protect San Francisco Bay from the worst of ocean-driven inclement weather (similar protection is provided by the Coronado peninsula for San Diego Bay, and the Rockaway Peninsula for Jamaica Bay). Paradise Island similarly provides protection to vessels in Nassau Harbour. Similarly are artificial structures such as the Causeway Bay Typhoon Shelter in Hong Kong that provide such protection.

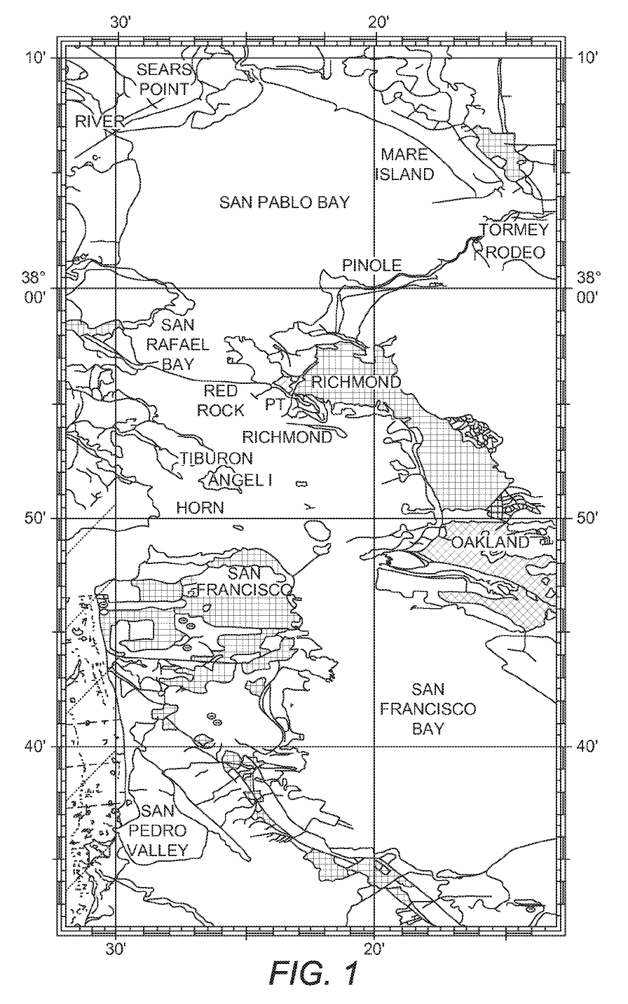

FIG. 1 is a chart of part of the San Francisco Bay, an example of a single urban region with a waterway, comprising San Francisco Bay (basically the region bounded by the Richmond, Golden Gate and San Mateo bridges) and San Pablo Bay (the region north of the Richmond Bridge). Not depicted is South Bay (the region south of the San Mateo Bridge). Angel Island appears approximately in the center of the chart, with the city of San Francisco to the south (and with Alcatraz Island between Angel Island and San Francisco), and the cities of Oakland and Berkeley to the east.

Some characteristics of an urban region with a waterway, as illustrated using San Francisco Bay, include the adjacent city/cities of San Francisco, Oakland, Berkeley and Richmond; where the adjacent ocean is the Pacific Ocean; where the (natural) isolating barriers are the hills of San Francisco and Marin counties; where the two-dimensional navigational routes include in/out-bound ocean traffic from the Golden Gate Bridge to the piers/docks of South San Francisco, Oakland and Richmond, ferry traffic between San Francisco, Alameda and Marin counties, as well as recreational and fishing vessels crisscrossing the Bay; and where there are ample resources and opportunities, including: social (e.g., Fisherman's Wharf, China Town, North Beach, and Jack London Square); medical (e.g., University of California at San Francisco Hospital); educational (e.g., UC Berkeley and UC San Francisco); occupational (e.g., the business districts of San Francisco and Oakland, etc.); entertainment (e.g., Union Square shopping and theater district); transportation (e.g., the MUNI, CALTRANS and BART public transit systems, with connections to the San Francisco and Oakland International airports); and telecommunications (e.g., the many landline, wireless, cable and Internet systems that are commercially available).

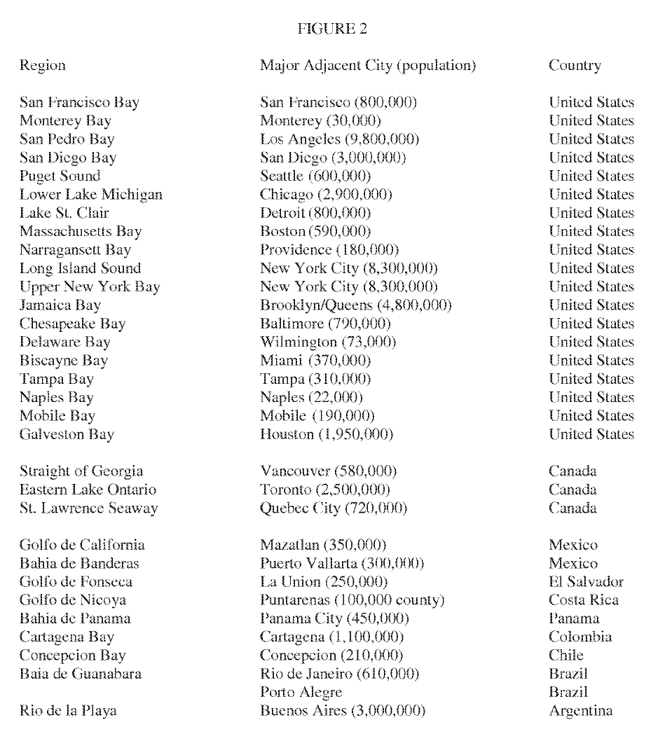

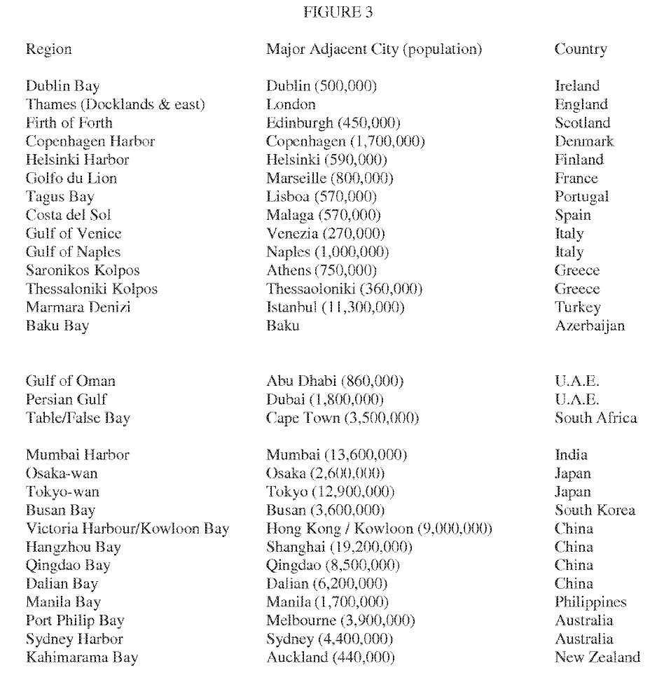

FIGS. 2 and 3 are exemplary lists of other single urban regions with waterways adjacent to attractions that are similar to those available in the San Francisco Bay region, other regions in which the systems, structures and methods disclosed herein can be used. In the United States, there are the bays of Boston (Boston Harbor, and Cape Cod and Buzzards Bays), Puget Sound (centered on Seattle, Wash.), New York Harbor (especially the Upper and Lower New York bays), Long Island Sound (located between Connecticut and Long Island), Chesapeake Bay (adjacent to the city of Baltimore), and Tampa Bay. Throughout the world in the Americas, Europe, Africa and Asia, there are other urban regions with waterways, such as Victoria Harbour/Kowloon Bay adjacent to the cities of Hong Kong and Kowloon, Port Phillip Bay adjacent to the city of Melbourne, and Baia de Guanabara adjacent to Rio de Janeiro.

Not all of the waterways listed in FIGS. 2 and 3 have all of the characteristics of waterways such as San Francisco Bay. Massachusetts Bay adjacent to the city of Boston on the Atlantic Ocean, Santa Monica/San Pedro bays adjacent to the city of Los Angeles, and Bahia de Panama adjacent to the city of Panama on the Pacific Ocean, have lesser degrees of isolation from the ocean (and thus can have more inclement surface water conditions that have to be compensated for, such as high waves from storms in the ocean off of Boston), and/or having shallow bays (such as the waterways close to shore in Boston and Panama City). In some cases, offshore (covered) harbors (for example, similar to Japanese patent application JP63002789 for an offshore harbor for yachts) can be built to shelter the vessels that are disclosed herein during inclement water conditions, or coastal land can be purchased to build a traditional marina or harbor.

Similarly, the coastal waterways of Beirut and Tel Aviv can be tranquil enough (due to the calm waters at the Eastern end of the Mediterranean Sea) that a NUFORSs has little need for natural/artificial structures for protection from rougher sea conditions. A NUFORS can be navigated near the coast of such cities, for example, hugging the Beirut shoreline, back and forth, between the northern beach of Aajram, passing by the western end of Beirut, to the southern beach of Ramlet Al-Baida, along a route of approximately 12 miles in one direction.

Some urban waterways near the bays can be used for the structures, systems and methods that are disclosed herein. Cities such as Wilmington/Philadelphia and Quebec are near bays in that their immediate waterways (Delaware River; Saint Lawrence River) are immediate to coastal waterways (Delaware Bay, Gulf of Saint Lawrence).

### 6.2.1 Illustrative Example—San Francisco Bay

In a variety of sections of the Detailed Description below, the San Francisco Bay region is used as the location for a variety of examples that teach how to use the systems, structures and methods that are disclosed herein in other urban regions with waterways. These examples that are disclosed herein can be used analogously by a NUFORS in any urban region, similar to the San Francisco Bay region, that has a waterway with regulated shipping channels, anchorage areas, land-based transportation portals (piers, docks) and other constraints on navigation for which the systems, structures and methods that are disclosed herein that provide useful solutions.

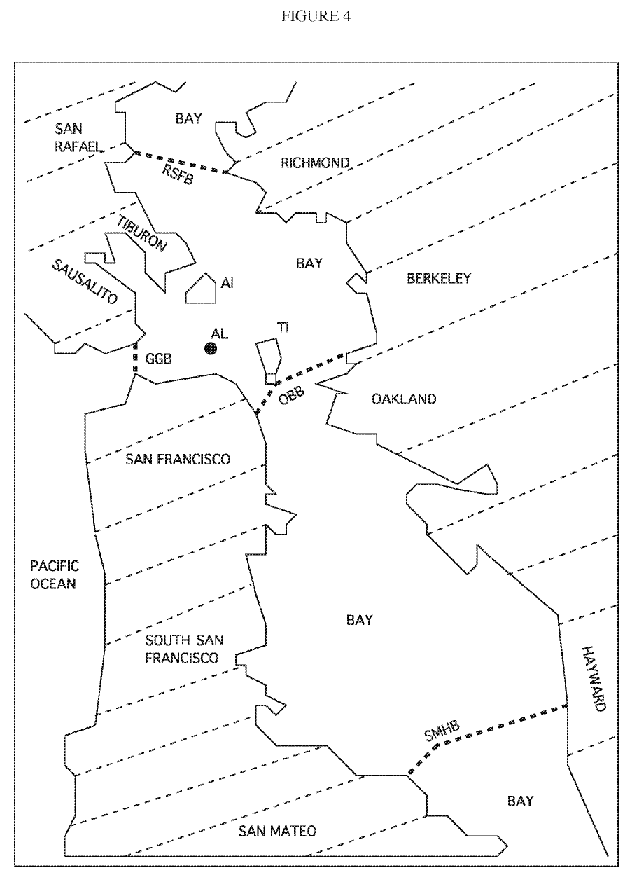

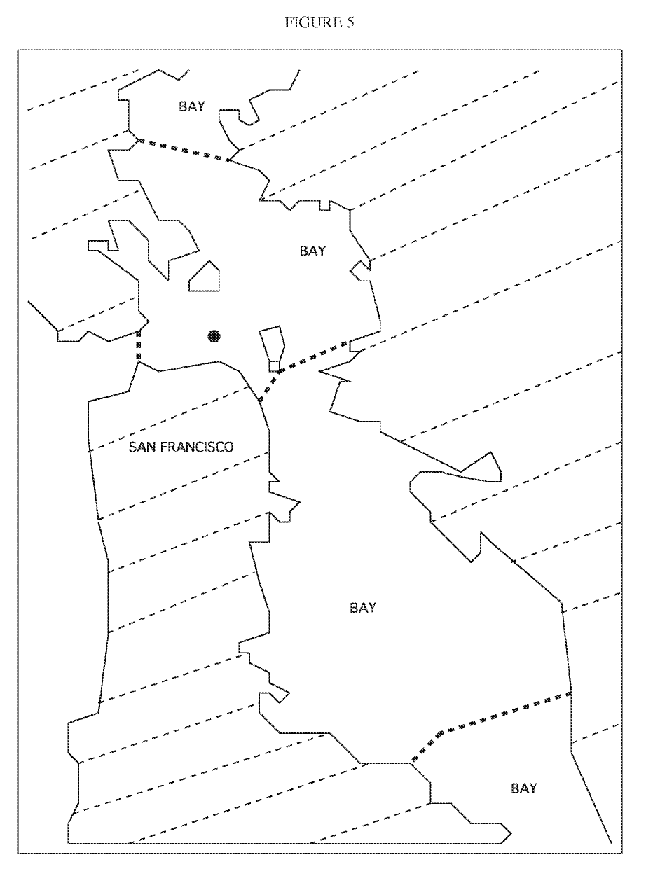

FIG. 4 is a generalized diagram of the San Francisco Bay region, depicting the major cities and landmarks. The labels “SAN FRANCISCO”, “SAUSALITO”, “TIBURON”, “SAN RAFAEL”, “RICHMOND”, “BERKELEY”, “OAKLAND”, “HAYWARD”, “SAN MATEO”, and “SOUTH SAN FRANCISCO” refer to cities adjacent to the bay. The bay waters are labeled by “BAY”, and the ocean waters are labeled with “PACIFIC”. The labels “GGB”, “RSFB”, “OBB” and “SMHB” refer to the Golden Gate, Richmond San Rafael, Oakland Bay and San Mateo Hayward bridges. Finally, three main bay islands are labeled as “Al”, “AL”, and “TI”, referring to the Angel, Alcatraz, and Treasure/YerbaBuena islands.

In some examples below, Alcatraz Island is used as a reference point for navigation purposes (or, for example, in Puget Sound, one can use Blake Island as a reference point; or in Sydney Harbor, one can use Fort Dennison as a reference point). Alcatraz Island is located approximately at a longitude of 122 degrees, 25.5 minutes west and at a latitude of 37 degrees, 49.5 minutes north. Blake Island is located approximately at a longitude of 122 degrees, 29.5 minutes west and at a latitude of 47 degrees, 32.25 minutes north. Fort Dennison is located approximately at a longitude of 151 degrees, 13.5 minutes east and at a latitude of 33 degrees, 51.3 minutes south. Globally, one nautical mile is approximately one minute of latitude in distance. At the equator, one nautical mile is approximately one minute of longitude in distance. In the region of San Francisco Bay, one nautical mile is approximately one minute, 16 seconds of longitude in distance. By international agreement, one nautical mile is defined as 1,852 meters.

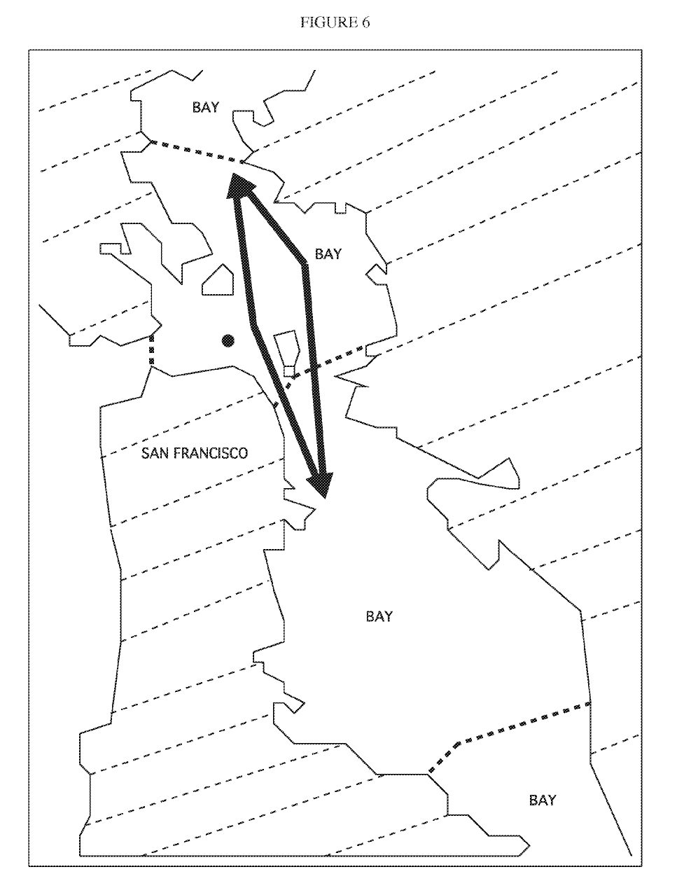

FIG. 5 is the diagram of FIG. 4 minus many of the annotations, to be used as a template below to illustrate exemplary navigational routes in a waterway that solve technical problems caused by the constraints of operating a NUFORS.

### 6.3 Exemplary Vessels

A variety of individual vessels, and couplings of vessels, can be used to support residences or offices that are based on the systems and methods disclosed herein, especially vessels with hull designs and engine configurations that require minimal amounts of energy for slow-speed travel (e.g., one nautical mile per hour) while providing maximal stability under regular conditions of the water surface. Any such vessel is sufficient, as long as it can be navigated using the systems and methods disclosed herein. Such a vessel can either be self-propelled, or propelled (e.g., pushed or pulled) by another vessel such as a tugboat.

An example of one vessel that can be used to support residences is a barge. A barge can provide a large surface area for supporting residences and/or offices, with leisure and recreational spaces adjacent to the residences and/or offices (e.g., lawns or gardens). Additionally, the long length and wide widths of barges result in moments-of-inertia that minimize uncomfortable rocking or rolling of the barge due to regular water conditions.

Examples of other vessels that can be used to support residences based on the systems and methods disclosed herein include double-hull catamarans often used as a ferry on a bay; and couplings of individual vessels, for example mechanically and/or electrically coupling at least two motorboats or yachts to create similarly-sized residential spaces as available on a barge. For example, 12 motorboats can be arranged in a 6 by 2 column format, with some engines removed and the remaining engines jointly controlled by a navigation system.

Additionally, publication of this disclosure, and initial commercialization activities, will attract the interest of vessel designers, who can create new designs for vessels to make maximum use of the structures, systems and methods disclosed herein, especially with regards to navigation and energy management.

Any type of engine can be used to propel such vessels, including engines fueled by diesel, gasoline, electricity, and/or biofuel. The low horsepower requirements to navigate such vessels at slow-speed in urban regions with generally moderate to hot climates allows diesel engines to be used to propel the vessel's movement, where the diesel engines are modified to use simple fuels derived from biomass such as methanol or dimethyl ether (DME).

For example, consider a barge of dimension 270 feet by 50 feet (approximately 82.3 meters by 15.2 meters). The surface of the vessel can be divided into different partitions for residences. For example, four 30 foot by 30 foot, two to four floor, residences can be built on the top of such a barge, with the remaining surface area covered with 10 foot wide areas of grass and dirt between residences to recreate the suburban household experience on a vessel. A 70 foot-wide barge can provide even more outdoor space for the residents. The remaining surface space can be used for a navigation tower and/or pad for a small helicopter. A bay structure can be fitted to the front or back of the barge with detachable connections for one or more tenders, to provide residents of the NUFORS with transport to land-based portals such as piers and docks.

### 6.4 Exemplary Residences or Offices

Residences or offices supported by a vessel used in the structures, systems and methods that are disclosed herein can be of a variety of architectural styles, and can be constructed from a variety of materials (e.g., wood, metal, plastics, canvas, etc.). The residences or offices can be mostly unattached to each other (as are houses typically in suburban areas), or mostly attached to each other (as are apartments in apartment buildings). There are few constraints on the architectural style and materials used to build the residences or offices, other than that they are physically supportable by the vessel. Architectural styles that minimize the weight load are preferred for lessening fuel requirements to move the vessel.

A variety of architectures are possible. For example, a storage area can occupy space under the surface deck of a barge. The first floor of a building, on the upper surface of the barge, can include a living room and dining room for a residence, or a reception room for an office. The second floor and third floor can include one or more bedrooms, or office space. Such residences can be similar in size and shape to townhouses found in residential complexes in cities (such as are found at the Golden Gateway Center in San Francisco). Or, for example, the exterior of the residence or office can have the shape of a geodesic, a pyramid, or a bottle of Patron tequila.

### 6.5 Exemplary Energy Management Systems, Methods and Economics

One technical problem solved with the structures, systems and methods disclosed herein is that of the fuel requirements that arise from the need to provide power to the engine(s) of a NUFORS to keep the vessel substantially in motion for a plurality of hours for most days of the year during which the vessel has to be navigated, if not for all hours of the days for all days of the year. Where long-term anchorage, in a mostly fixed location, is permitted by law, as an option, the NUFORS can save energy by mostly remaining at rest, navigating when necessary to satisfy applicable laws or needs of the occupants. Examples of routes for energy management and navigation for the San Francisco Bay region are disclosed below to teach how to solve such energy problems in any urban waterway.

Consider two possible daily navigational routes in the San Francisco Bay region. The first route is approximately travelling each day between two anchorage points between General Anchorage 9 offshore from Hunters Point in San Francisco (approximately at a longitude of 122 degrees, 21 minutes, west; latitude of 37 degrees, 44 minutes, north), and General Anchorage 5 offshore near Red Rock island (approximately at a longitude of 122 degrees, 26 minutes, west; latitude of 37 degrees, 56 minutes, north). Specifications for latitude/longitude that are disclosed herein can be used as entries for coordinates for navigational routes programmed into automated navigational systems operable to guide the movements of a NUFORS.

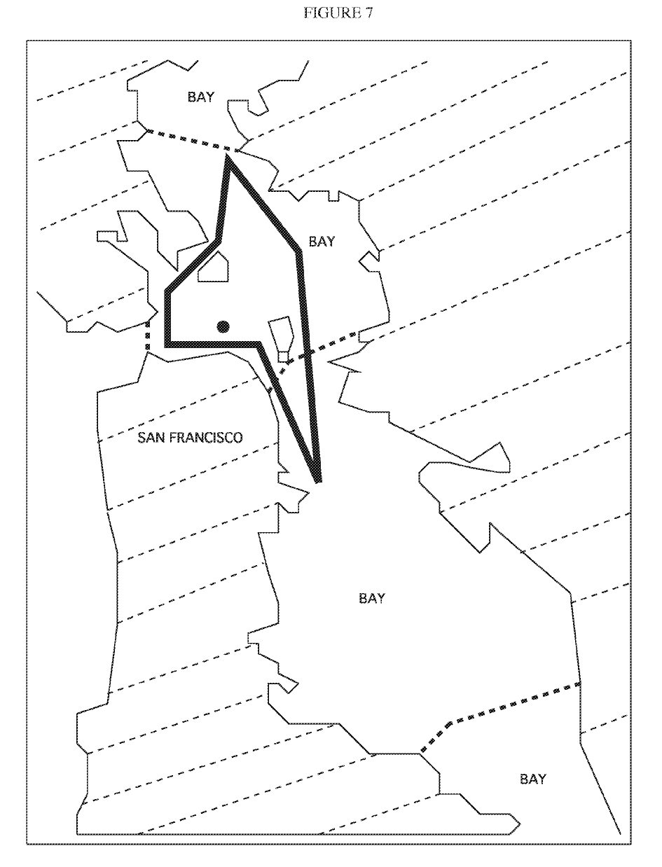

The distance between two anchorage points in those two areas is approximately 12 nautical miles, creating a daily travel distance of 24 nautical miles, for example, at an average speed of one nautical mile per hour (also known as a “knot”). FIG. 6 depicts two such routes as thick-arrowed lines, one route east of Treasure Island, and one route west of Treasure Island. The route east of Treasure Island has the advantage of mostly traversing General Anchorage areas where there is less large cargo traffic.

In general, many waterways in urban regions have space for navigational routes for a NUFORS that can be approximately 24 nautical miles. For example, one navigable route can be a route of 12 nautical miles long in the Hudson River between Manhattan and New Jersey, in that part of the Hudson River often referred to as the “North River” (the island of Manhattan is approximately 13.4 miles in length). Another example of a navigable route can be a route in Puget Sound with a northern end approximately near Seattle and a southern end approximately one third of the distance to Tacoma near the northwestern part of Vashon Island (the land distance between Seattle and Tacoma is approximately 32 miles). Another example of a navigable route can be a route with a northwestern end near the city of Baltimore and a southeastern end offshore of Riviera Beach that borders on the northern part of Chesapeake Bay. Another example of a navigable route can be a route with one end in the anchorages between the islands of Lantau and Hong Kong, and the other end in Victoria Harbour. Many of these navigational routes can pass through at least one anchorage area.

Minimizing fuel consumption at slow speeds (e.g., 1 nautical mile per hour) increases the utility of the vessels disclosed herein. For example, the two Bay of San Francisco routes depicted in FIG. 6 can be traversed by a one residential unit NUFORS that is equivalent in size to three American Tug 49 boats from Tomco Marine Group (La Conner, Wash.). This NUFORS has an equivalent length of about 50 feet and width of about 40 feet. If one creates a 10 foot wide grass lawn about the residential unit, there is left a building area of approximately 30 feet by 20 feet, space for a townhouse with two or three bedrooms, kitchen, dining area, living room and storage area. The American Tug has approximately a five-foot draft (draught), and thus is navigable throughout most waterways in urban regions around the world, except for areas very near to the shore.

Published ratings for the American Tug 49 show that one boat requires about 0.33 gallons per hour at one to two knots, so that the equivalent of three boats in motion all day long between the two General Anchorages as depicted in FIG. 6 will require approximately one gallon per hour, or 8760 gallons per year. Marine diesel per gallon costs approximately 25% more than diesel for automobiles. Assuming a cost of $4 per gallon for automobile diesel results in marine diesel costs of about $5 per gallon, which for 8760 gallons per year, creates an annual fuel cost of approximately $44,000 per year. For example, if the owner of a residence of a NUFORS deposits 1,000,000 in an interest-earning bank account earning 4.4% a year (or invests in a preferred stock), then the owner will have sufficient funds to cover his or her share of the costs of the fuel. This coverage of the fuel cost by a resident allows the NUFORS to remain in motion all hours of the day for all hours of the year, for those urban regions where regulations do not permit the NUFORS to remain at rest. Where regulations permit the NUFORS to make use of resting areas, such as anchorage areas, for at least a few hours a day, and/or for at least a few days a year, less fuel is needed for the NUFORS to be navigated most hours of the day for most days of the year, and less money needs to be made available by the occupant. For example, when the NUFORS is in motion three quarters of the time (e.g., at rest approximately 6 hours each day, for example, anchoring in a General Anchorage area approximately from 1 AM to 7 AM when many residents might be asleep), then the annual fuel cost drops to $33,000 per year, and thus requiring a 3.3% return in a bank account.

Minimizing fuel consumption by using slow speeds for the NUFORS (e.g., 0.5 to 2 nautical miles per hour), as well as being constrained by the occupants of the residences or offices who want to make regular use of one urban region, generally restricts the NUFORS to remain within one urban region. At a higher speed of 2 to 3 nautical miles per hour, a NUFORS has a half-day range of about 20 to 30 nautical miles, and at least for the urban regions listed in FIGS. 2 and 3, none are within 50 nautical miles of each other (while multiple bays are listed for the New York City region, they are all one contiguous urban waterway). In some cases, an excursion trip may be possible to one other urban region (for example, the distance from Seattle to Vancouver is about 110 miles), with the residents agreeing to cover the costs of the extra fuel needed for higher speeds. Generally, though, the navigation of a NUFORS is limited to the waterways of one urban region.

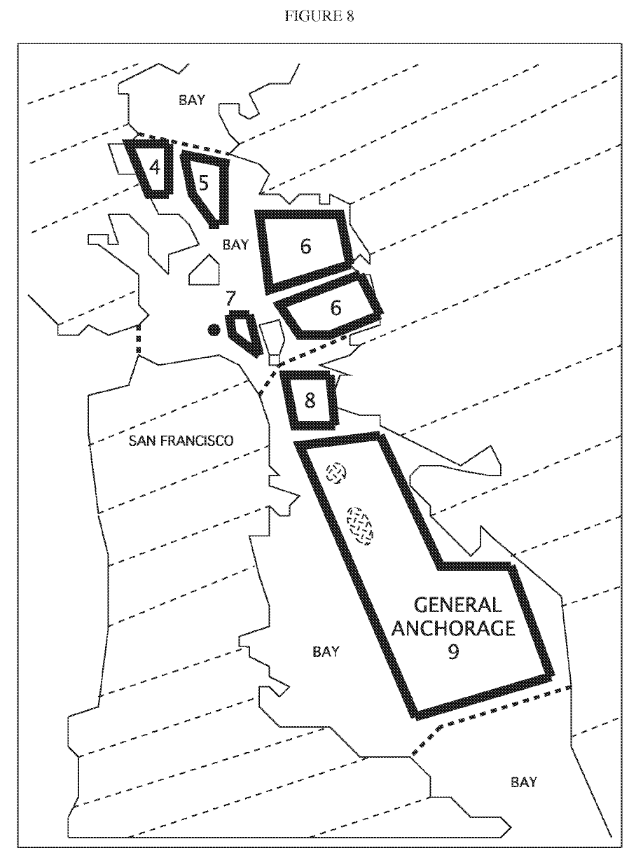

Another exemplary navigational route can have a navigational distance of approximately 96 nautical miles, four times the distance of the first scenario. FIG. 7 depicts a closed route in the Bay of San Francisco for which one circuit is somewhat longer than the route depicted in FIG. 6. The route depicted in FIG. 7 can be traversed three to four times a day, or only once or twice day, with some legs of the route traveled at a higher speed (4 to 8 knots) where such legs traverse Regulated Navigation Areas with more traffic. This longer distance allows the NUFORS to pass by land-portals (e.g., the Ferry Building in San Francisco) multiple times (e.g., morning, noon, evening, midnight) for residents to go ashore or return to the NUFORS, as well as pass through scenic areas (such as in the vicinity of Angel Island). The annual fuel cost for navigating the NUFORS all hours of the day for all days of the year, approximately $132,000, can be paid for by earning a 6.6% return on a $2,000,000 account balance.

A NUFORS can also be compared to a group of 32-foot Nordic Tug 32 boats (NT32) (available from Nordic Tugs, Burlington, Wash.). Four such tugs provide enough surface area and engine power to transport the equivalent of one residence on the NUFORS. At six nautical miles an hour, the NT32 requires approximately one gallon of gasoline an hour, or four gallons an hour for the four NT32s. At $5/gallon for fuel for the NT32, the fuel cost for transporting the equivalent of one residence on the NUFORS is approximately $20/hour, or about $170,000/year if the NUFORS is continually moving. At six nautical miles per hour, an NUFORS, for example, can travel much further throughout the San Francisco bay, including into San Pablo Bay north of the Richmond San Rafael Bridge, and as far south as the Dunbarton Bridge. Similarly, at six nautical miles per hour, a NUFORS can travel further up the Hudson River, further north or south away from Seattle, or further away from Baltimore into more of Chesapeake Bay.

Residents of a NUFORS can deposit a few million dollars into an escrow account, the interest of which can be used to cover the fuel costs (and other costs such as labor). When the resident sells his residence to another party, his/her deposit is returned, and the new resident can be required to deposit a similar amount. Or the resident can sign a contract agreeing to periodically pay for their share of the fuel cost via check or bank transfer. In addition, residents can also deposit a few million dollars into another escrow account, with interest/dividends earned allocated to pay salaries for pilots and crew members (or the resident can sign a contract guaranteeing periodic payments). Alternatively, the developer of a NUFORS can fund such accounts with part of the profits of sales of a NUFORS.

Alternatively, some of the deposited money can be invested in the production of renewable biofuels, some of which can be used to fuel the engine or engines of the vessel, and/or some of which can be sold in the energy markets to provide income to pay for other operational expenses. One type of renewable fuel can be dimethyl ether (DME), which can be produced from methanol by dehydration, and is a liquid at room temperature under low pressure (providing half the BTUs/gallon as compared to gasoline). DME has no carbon-carbon bonds, so it doesn't produce soot particulates or black smoke when burned, and requires a lower pressure for fuel injection. A variety of diesel engines for navigation uses can be modified to run on DME (with or without additives). Methanol can be produced by the plasma gasification of biomasses such as hemp, switchgrasses, and agricultural wastes such as sugar cane bagasse, in some cases, for a few dollars per gallon, with industrially produced methanol available approximately for one dollar per gallon. For every two gallons of DME that is produced, one gallon can be sold to cover costs, and the other gallon used to power the vessels disclosed herein. With NUFORS vessels in multiple urban waterways in North and South America, one can locate a biofuel production facility, for example, in Central America (e.g., Costa Rica and/or Panama, two countries with ample amounts of sun and rain ideal for growing biomass), with some fuel optionally sold into local markets while the remaining fuel is shipped north or south.

Using a barge as the foundational vessel for the residents requires less power (and therefore less fuel) than the equivalent of three American tug 49s or four NT32s to transport the equivalent of one residence on a NUFORS, and for many urban waterways, there are tides that can be used to move a NUFORS (for example, the morning tides in the Bay of San Francisco from the ocean inwards can flow up to four knots, with the afternoon flows in the opposite direction). Additionally, a NUFORS can be powered by solar-diesel hybrid engines, such as some engines sold by Island Pilot (www.dsehybrid.com), with some of the surface area of a NUFORS being covered with solar power cells. These factors further reduce the annual fuel cost for each residence of a NUFORS, or with the fuel saved, allow the NUFORS to be navigated more rapidly and/or for farther distances.

An alternate solution to the problem of providing fuel to a NUFORS can be to use electric engines that are supplied with renewable energy sources and/or power generators that use fuel. For example, Independence Green Yachts, offers for sale a 60 foot yacht powered solely by solar cells panels installed on the roof of the yacht. Electricity from the solar cells is used to generate hydrogen from water, with the hydrogen stored in metal hydride storage systems to be used later in fuel cells to generate electricity to power the electric engines that propel the yacht (alternatively, electricity from the solar cells can be stored in batteries for future use). For navigation at slow speeds (up to a few knots), sufficient power can be generated, though at a much greater expense than traditional fuel sources for vessels (while 60 foot yachts can cost many hundreds of thousands of dollars, Independence's green yachts cost over $2,000,000).

Such financial calculations show that residents with sufficient income can cover the costs of their share of the fuel to keep their NUFORS mostly in motion most hours of the day, for most days of the year (if not for all hours of the day for all hours of the year), as compared to people with sufficient income to cover the costs of financing residences on land that provide equally pleasurable views. For example, a penthouse in downtown San Francisco in the St. Regis Residences, has four terraces that provide a 360-degree panoramic view of the San Francisco Bay region. The penthouse was bought for about $30,000,000 in 2005 and in 2008 was put up for sale for $70,000,000 (“A $70 million view, S. F. seller hopes”, San Francisco Chronicle, 28 Aug. 2008, page C1). While the high price is due much in part to location and elaborate furnishings inside the apartment (such as a two-story waterfall, and a 13-seat movie cinema), millions of dollars of the value of the penthouse is due to the Bay views. An uncompleted villa at 2920 Broadway in San Francisco was sold for $32 million, again with millions of dollars of the value of the penthouse due to the Bay views it provides. Land itself in urban areas is quite valuable, even before housing is constructed. For example, at the end of 2010, Salesforce.com acquired 14 acres in Mission Bay (south of downtown San Francisco) for $278 million.

### 6.6 Exemplary Navigational Systems and Methods

For a NUFORS to be useful, a variety of transportation, logistics and safety problems should be solved simultaneously, constrained by the requirements of individuals, families and/or workers occupying a NUFORS. These problems include: 1) providing a navigation system that mostly continually moves a NUFORS, usually at slow speeds, subject to federal, state and/or local navigational laws and regulations; 2) providing a navigation system that navigates a NUFORS with convenient access to land portals that connect to, or are nearby to, land-based transportation, work, health, leisure, etc., services, systems and locations; 3) providing a navigation system that provides navigation for medical emergencies; 4) providing a navigation system that satisfies periodic and random requests of inhabitants of a NUFORS to access land portals; 5) providing a navigation system that can use renewable energy resources (e.g., tidal flow, solar and wind) to help navigate a NUFORS; 6) providing a navigation system that satisfies periodic and random transfers of supplies to/from a NUFORS; 7) providing a navigation system that can handle random navigation interactions that may negatively harm a NUFORS; 8) provide a navigation system for a first NUFORS that can interact with the navigation systems of a nearby NUFORS; 9) provide a NUFORS that minimizes use of energy and water and/or minimizes the volume and toxicity of wastes; and/or 9) providing equipment to minimize the need for navigation for water and waste disposal.

6.6.1 Navigation for a NUFORS that is Constrained by Laws or Regulations

Urban waterways are subject to multiple federal, provincial, state and/or local laws and regulations. Usually such laws or regulations are enforced by a coast guard (for example, the United States Coast Guard), or equivalent governmental agency. In the United States, some of the government agencies involved with such laws and regulations include the Navigation Center of the U.S. Coast Guard (www.navcen.uscg.gov) nationally, and Sector San Francisco Vessel Traffic Service of the U.S. Coast Guard (www.uscg.mil/d11/vtssf) locally. Background information on, and aerial photographs of, port facilities for urban regions with waterways such as those disclosed in FIGS. 2 and 3 is available on the Internet (e.g., www.worldportsource.com).

In the United States, the Coast Pilot series is a set of nautical books with a variety of information important to navigators of waterways, including information on channel descriptions, coordinates and regulations for using anchorages, bridge and cable clearances, currents, tide and water levels, prominent features, pilotage, towage, weather, ice conditions, wharf descriptions, dangers, routes, traffic separation schemes, small-craft facilities and Federal regulations that are applicable to navigation. The series, comprising Coast Pilot 1 to Coast Pilot 9, are available at: www.nauticalcharts.noaa.gov/nsd/cpdownload.htm. Coast Pilot 7, for example, includes information on San Francisco Bay.

Many urban waterways have regular traffic that, much like for a NUFORS, are constrained by these laws. For example, in the San Francisco Bay region, there are ferry services between San Francisco, Oakland and Marin County (Sausalito, Tiburon and Vallejo), with multiple ferry rides between these four cities/towns each day, all such trips satisfying governmental laws and regulations (as must trips conducted by cruise ships and cargo ships that travel in the bay). In Puget Sound, for example, there are ferry services between Seattle and Bainbridge Island, Bremerton and Vashon. In Rio de Janeiro, there is the Rio-to-Niteroi ferry. For a NUFORS, with its generally slower speed, and with one goal of navigating to more desirable vistas, the navigation system can be programmed to determine routes for a NUFORS that intersect for as little time as possible with routes for more regular traffic, such as ferries, and cruise sips and cargo ships.

Faster irregular traffic, such as power boats, or slower irregular traffic, such as sail boats, tend to sail at certain times (e.g., weekends) and locations (e.g., between Angel and Treasure islands in San Francisco Bay), so that a NUFORS navigation system can be programmed to avoid such areas when there is a high density of boats at these times.

Returning to the example of the waterways of San Francisco Bay, the following are examples of navigational rules that can apply to the navigation of a NUFORS. These rules are taken from the United States Coast Guard manual—“Navigation Rules: International—Inland”. Such rules correspond to federal laws in Title 33 of the United States Code, with supplementary information in Title 33 of the Code of Federal Regulations. Similar rules apply to waterways in urban regions for other countries that have adopted international navigation regulations.

Rule 9(a)—A vessel proceeding along the course of a narrow channel or fairway shall keep as near to the outer limit of the channel or fairway, which lies on her starboard side, as is safe and practicable.

Rule 9(d)—A vessel shall not cross a narrow channel or fairway if such crossing impedes the passage of a vessel which can safely navigate only within such channel or fairway. The latter vessel may use the sound signal prescribed in Rule 34(d) if in doubt as the intention of the crossing vessel.

Rule 9(f)—A vessel nearing a bend or an area of a narrow channel or fairway where other vessels may be obscured by an intervening obstruction shall navigate with particular alertness and caution and shall sound the appropriate signal prescribed in Rule 34(e).

Rule 9(g)—Any vessel shall, if the circumstances of the case admit, avoid anchoring in a narrow channel.

Rule 10(c)—A vessel shall, so far as practicable, avoid crossing traffic lanes but if obliged to do so shall cross on a heading as nearly as practicable at right angles to the general direction of traffic flow.

Rule 10(f)—A vessel navigating in areas near the termination of traffic separation schemes shall do so with particular caution.

For many waterways in urban regions around the world, in addition to the above laws that apply nationally, there can be local rules enforced by local, state and/or federal authorities. For example, the national United States Coast Guard has sectors, for example, Sector San Francisco, that regulate vessel traffic on waterways in their sector. USCG Sector San Francisco has rules, USCG Vessel Traffic Service San Francisco Users Manual (www.uscg.mil/D11/vtssf/vtssfum.asp), including the following rules that apply to a NUFORS, with similar rules in waterways in other urban regions.

Inshore Sector: Sailing Plan—A vessel shall provide a sailing plan to the VTS on channel 14 at least 15 minutes prior to getting underway from a berth or anchorage in the Inshore Sector. Position Reports: shall be made: once a vessel is actually underway or upon entry into a VTS areas; when passing a reporting point; and after pilot change, departure of pilot, or other change in person directing the movement of the vessel.

Route Intentions: All vessels shall be aware of and follow the San Francisco Bay traffic routing system. This system consists of a Traffic Separation Scheme (TSS) offshore and Regulated Navigational Areas (RNAs) in the Inshore Sector. Any decision to deviate from the TSS or RNA must be made by the master or person in charge of the vessel. You shall notify the VTS prior to deviating from TSS or RNA.

Anchorages (B). VTS administration of the anchorages includes ensuring proper separation of anchored vessels to prevent their swinging or drifting into each other. The COTP has established a mandatory separation of 750 yards around anchored vessels over 300 gross tons. Vessels anchoring with 750 yards, or which “settle out” within 750 yards of another vessel will be directed by the VTS to re-anchor at a greater distance. The vessel that was the last to arrive will normally be the one required to move.

Anchorages (F). No vessel may anchor in a “dead ship” status (propulsion or control unavailable for normal operation) at any anchorage, other than Anchorage 9, without the prior approval of the Captain of the Port. Any vessel anchoring in a “dead ship” status shall have one assist tug of adequate bollard pull on standby and immediately available (maximum of 15 minute response time) to provide emergency maneuvering. When the sustained winds are 20 knots or greater, or when the wind gusts are 25 knots or greater, the tug must be alongside.

Recreation Areas: Recreation areas are intended primarily for use by recreational vessels. Such areas should not be used by vessels of 300 gross tons or more, except in case of emergency or special circumstances.

Traffic Lanes: Traffic lanes are intended for use by vessels of 1600 gross tons and over; arrows on navigation charts indicate the appropriate direction of flow within each lane. The provisions of Inland Navigation Rule 9 apply to all vessels navigating in the traffic lanes.

Anchorages: Within the navigable waters of the Bay of San Francisco, anchoring is prohibited outside of designated anchorages except when required for safety or with the written permission of the Captain of the Port.

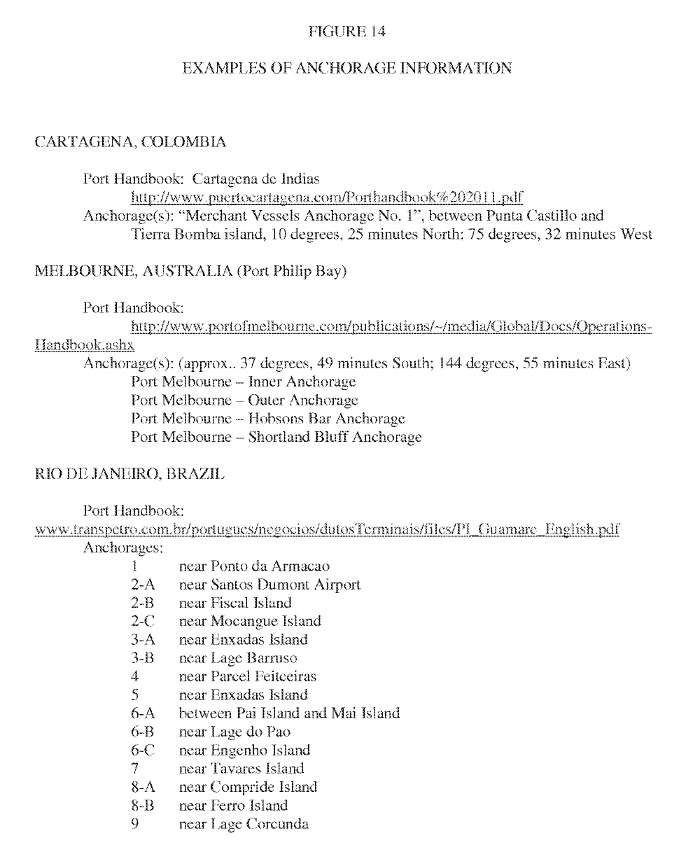

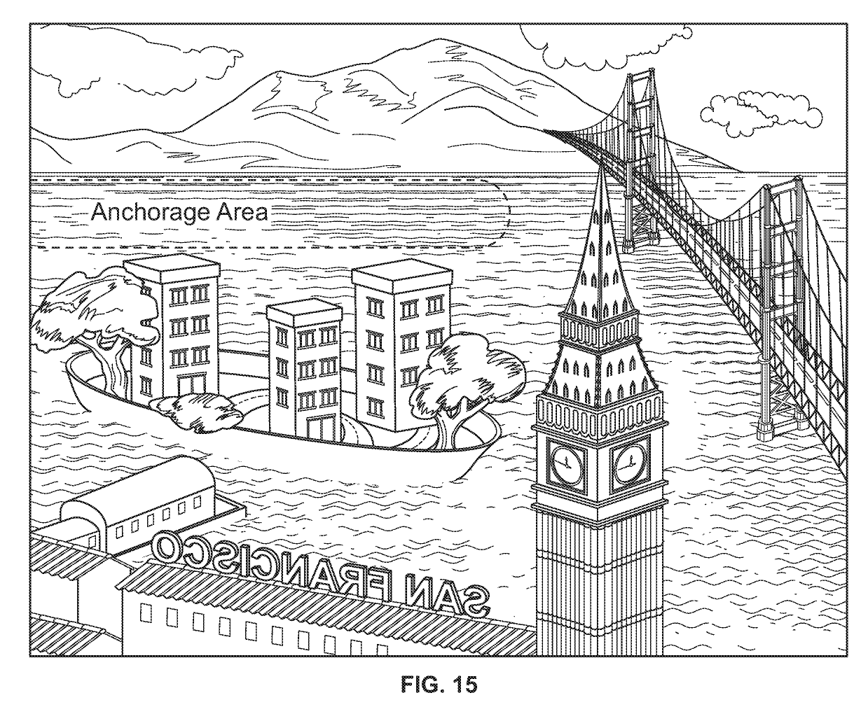

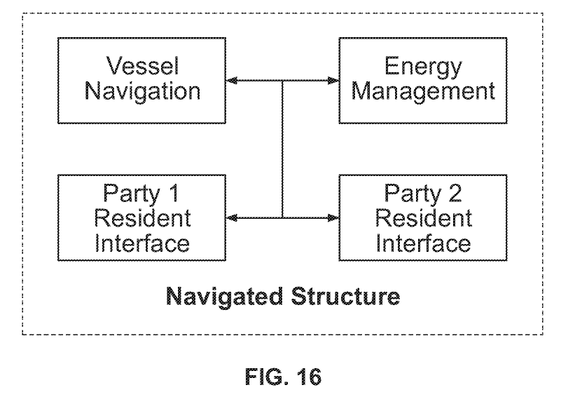

Other regulatory authorities around the world govern navigation in their ports and waterways, and conditions for uses of anchorages. For example, the Marine Department of the Government of Hong Kong Special Administrative Region administers the Port of Hong Kong (wwww.mardep.gov.hk/en/index.html). Administracao do Porto de Lisboa administers the ports for Lisbon. FIG. 14 contains examples of anchorage information from around the world. A variety of publications, including the “Guide to Port Entry” (Shipping Guides Ltd, Reigate, Surrey, UK) and the “World Port Index” (National Geospatial-Intelligence Agency, Bethesda, Md.), provide a variety of information about ports and bay, including anchorages and local navigation rules, for most ports around the world.

6.6.2 Navigation for a NUFORS that is Constrained by Access to Land Portals

Periodically, often multiple times a day, a NUFORS can be navigated to provide access to land portals, so that occupants can be transported to transportation systems on land, to be able to travel to locations for work, shopping, entertainment, etc. Such access can be arranged at fixed times each day (e.g., circa 8 A.M. for traveling to work, 6 P.M. for traveling back to a NUFORS, etc.) Other times for transport can be arranged at the request of one or more occupants. Occupants can be transferred by a variety of tenders.

For example, consider San Francisco bay, where residents of a NUFORS want to make use of facilities and services in the city of San Francisco. The navigation system can navigate a NUFORS so that the NUFORS passes close by (or docks at) the piers at the Ferry Building and/or near Fisherman's Wharf. For nearby passage (for example, through Temporary Anchorage 7), a tender attached to the NUFORS can transport residents to/from the NUFORS and piers. Once at a pier, the residents can transfer to ground-based transportation (foot, bike, rental car, cab, limo, public transit, etc.). The Ferry Building (and nearby piers) is approximately at latitude 122 degrees, 23.5 minutes and longitude 37 degrees, 48 minutes. Fisherman's Wharf (and nearby piers) is approximately at latitude 122 degrees, 25 minutes and longitude 37 degrees, 48.8 minutes. One location inside Temporary Anchorage 7, convenient for transfer using a tender from the NUFORS to any of these piers in San Francisco, is at latitude 122 degrees, 23 minutes and longitude 37 degrees, 49 minutes.

Traversing such pre-arranged connections typically don't require much time, given the close proximity of a NUFORS to the land-based portal (for connections without docking). Random connections requested by occupants when a NUFORS is farther from such portals impose an extra time burden on the occupants, for example, in terms of extra travel distance for the tender. For most hours of any one day, a NUFORS can remain mostly close to one side of a bay (e.g., closer to the San Francisco side of San Francisco Bay), if most or all residents prefer to connect to land portals on that side of the bay.

For some waterways in an urban region, boat slips can be rented/owned to allow occasional docking of a NUFORS. For example, in Seattle, the Salmon Bay Marina Center (www.sbmcseattle.com) leases or sells slips that can accommodate vessels from 100 feet to 275 feet, with office and residential space in the vicinity of the slips. Such space can be used by a resident of a NUFORS who desires to remain on land for a few nights, or who has missed one of the periodic transports to a NUFORS. For example, in the San Francisco Bay region, NUFORS docking space may be leased in the Oakland Outer Harbor adjacent the now-closed Oakland Army Base. For example, in the New York City region, NUFORS docking space may be leased in the vicinity of where the Newtown Creek meets the East River.

### 6.6.3 Medical Emergencies

If a resident has a sudden desire for Chinese food (e.g., from Hunan Home's Restaurant, in San Francisco), but a NUFORS is too far from a land portal, well, that's a disappointment/failure for the resident who has to wait until a connection is more logistically feasible. But if a resident has a dire need for medical services, there can be no failure. For regular medical needs (e.g., such as a checkup or minor toothache), for which the resident is mostly ambulatory, periodic connections to land portals can suffice in terms of convenience for seeking treatment. For more critical medical conditions, when a NUFORS is sufficiently close to a land portal, and the resident is mostly ambulatory, the NUFORS can be navigated towards a land portal that is accessible by ambulance, where the resident, for example, can be transported via a tender. For example, in San Francisco Bay, a NUFORS can be navigated close to the piers that are near 20^{th} and 3^{rd} Streets. The resident can be moved by tender to a pier, and met by an ambulance or other vehicle, and driven a short distance up 20^{th} Street, and then one block left onto Portero Street to the San Francisco General Hospital.

When the resident is not ambulatory (e.g., a heart attack or stroke), or the medical condition requires much more immediate treatment, arrangements can be made for transfer, by a helicopter or by the Coast Guard, of the medically-impaired resident, to a hospital with a trauma center. For a NUFORS with sufficient space, a small helicopter (such as the Robertson R22) can be stored onboard for use in emergency trips (and/or used for recreational trips). For example, in San Francisco Bay, a helicopter can be used to transfer a medically-impaired resident to the centrally-located Oakland Children's Hospital (or the future UCSF Mission Bay Med Center).

6.6.4 Navigation for a NUFORS that is Constrained by Requests of Occupants of a NUFORS

Navigation terminals in each residence or office can provide occupants with partial access to the navigation system of a NUFORS, for example, to allow the residents to view graphical displays of the current and projected positions of the NUFORS, and to allow occupants to request changes in the schedule of the timing of future connections to land portals, etc.

With such terminals, residents can enter requests for additional connections, which the navigation system can use to determine the feasibility of providing navigation for such connections, before indicating approval to the resident. For example, if a NUFORS passes the San Francisco Ferry Building once an hour on the hour during the day, and a resident requests a connection at the half hour, and there are no requests from other residents, the navigation system can determine if such a connection is possible (e.g., if nearby traffic is light, the NUFORS can be navigated to drift back and forth offshore near the Ferry Building). The navigation system can be programmed to require a minimum time (e.g., 30 minutes) as advance warning for any navigation requests of the resident, and can bill a cost if the required fuel exceeds some agreed upon level.

Also, residents can request for specific navigation routes that provide specific vistas of the region. For example, in San Francisco Bay, if there are no requests from other residents, and bay traffic is light, the navigation system can determine a navigation route that satisfies a resident's request to travel about Angel Island.

6.6.5 Navigation for a NUFORS that is Constrained by Use of Renewable Energy Sources

A NUFORS imposes an additional energy cost on its residents as compared to residents who are moored—the cost of the fuel needed to propel the vessel so that the NUFORS can travel along the calculated navigational routes. One way to minimize such energy costs can be to use renewable energy resources, such as tidal flows and solar energy panels (to provide power to electric propulsion motors).

For example, in San Francisco Bay, a NUFORS can use tidal flows to move up to the North Bay region, where with less water traffic, the NUFORS can save energy by remaining mostly at rest. When the tide reverses (on the same day, or a following day), the NUFORS can move back to the central region of the bay. Similar tidal flows, for example, can be used in the Tagus Bay near Lisbon.

6.6.6 Navigation for a NUFORS that is Constrained by Transfers of Supplies

Periodically, though less frequently than the daily connection needs of the residents or occupants to land portals, a NUFORS needs to connect to land portals for facilitating the transfer of operational supplies and/or wastes. For example, such transfers can occur during times when residents are imposing few navigational burdens, such as at night when the residents can be sleeping, or during the day when the residents can be onshore. Alternatively, arrangements can be made for another vessel to transport supplies and/or wastes to and from a NUFORS.

Foremost for transfer can be operational supplies for navigating a NUFORS (e.g., fuel, oil, and engine equipment), which can be acquired at traditional port facilities. Such fuel can be used to navigate a NUFORS, provide heat for residents, provide electricity for residents, etc. An additional provision to be acquired is water, both for the needs of a NUFORS (e.g., cooling and cleaning equipment) and the personal needs of occupants (e.g., bathing, cleaning, consumption). Transfer of mail, food supplies, office supplies, and household items can be handled at the same time.

The navigation computers on a NUFORS can be used to prepare orders of foods and other stuffs based on requests from one or more residents. For example, such orders can be forwarded to local supermarkets (e.g., Safeway in San Francisco, Zona Sul in Rio de Janeiro, Coles Supermarkets in Sydney) and the like (e.g., Waiters On Wheels in San Francisco) for fulfillment and delivery to a land portal, after which ordered items are eventually conveyed to a NUFORS.

Acquiring supplies eventually leads to the need to eliminate wastes. For example, small volumes of waste can be temporarily stored on a NUFORS, and then transferred to a waste disposal service based on land. Any urban waterway that experiences cruise and cargo ships already has much of the port infrastructure needed to support the waste (and operational and personal supply) needs of a NUFORS. The wastes can be transferred using a tender associated with a NUFORS, or directly removed if the NUFORS is temporarily docked.

6.6.7 Navigation for a NUFORS that is Constrained by Random Harmful Incidents

A navigation system for a NUFORS can be programmed to deal with random incidents that threaten the safety of occupants and the integrity of the NUFORS. These incidents include collisions with other floating structures, collisions with fixed objects (e.g., bridges, underwater terrain), and accidents on the NUFORS.

In most of these situations, navigation of a NUFORS is stopped, or is substantially slowed. The navigation system can navigate the NUFORS in coordination with any rescue vehicle, e.g., with the slower NUFORS in motion according to orders received from a rescuing vessel (e.g., a Coast Guard cruiser).

6.6.8 Navigation for a NUFORS that is Constrained by Navigation of an Adjacent NUFORS

Given the popularity of the NUFORS concept, in any given urban region, there can be more than one NUFORS being navigated in the waterway, a community of sorts.

If more than one NUFORS use similar navigation systems, the navigation systems can be programmed to simultaneously navigate all of the NUFORSes. For example, three NUFORSes can be arranged in a column, with the NUFORS in front providing navigational guidance for the other two, similar to a floating train.

Alternatively, the navigation system of each NUFORS can model another NUFORS that is nearby, as just an additional vessel to be navigated away from at regulated distances.

A navigation system for a NUFORS can be programmed to occasionally move a NUFORS sufficiently close to another NUFORS to allow the transfer of supplies and people. This coordinated navigation can minimize the number of times that multiple NUFORSes need to access land portals to facilitate the transfer of supplies, as well as provides opportunities to create an extended-area NUFORS across which occupants can socialize.

### General System Configurations for Navigation and Energy Management

In view of the navigational considerations described above, the navigation system and/or energy management system of a NUFORS (possibly in conjunction with each other, or one system can be a sub-system of the other) may be configured or programmed to control movement of the NUFORS in the waterway of an urban region for all days of the year, or up to most or some days of the year, e.g., up to 365 (every day of the year), 310 (six days a week), 260 (five days a week), 182 (every other day of the year), 69 (five days a month plus nine holidays), or 52 (one day a week) days of the year, in accord with one or more of the following exemplary daily schemes for controlling the movement of the NUFORS:
a. the total length of the route of the NUFORS in a given day may be in the range up to 100 nautical miles;
b. the total length of time of movement of the NUFORS in the waterway in a given day may be less than 24 hours, with at least one period of time in a given day when the NUFORS is not subject to controlled movement (e.g., may be adrift in an anchorage, or moored to a pier);
c. the speed of the NUFORS when subject to controlled movement by the navigation system may be a substantially constant value between 0 to 9 knots, or the speed may be controlled to vary in a regular pattern within the aforementioned range;
d. the route of the NUFORS may be controlled by the navigation system to be one or more straight segments, in the form of a closed shape, such as a circular, elliptical, rectangular, trapezoidal, pentagonal, or hexagonal shape (and smooth shapes thereof), or a combination of these shapes (for example, a straight line segment, followed by a loop around an island, followed by a straight line segment); and
e. the route of the NUFORS in a given day may be controlled to have at least one stopping point in any given day, whereby a stopping point or area is a point at which or an area outside of which the NUFORS does not generally move relative to the earth's surface (aside from movement of the vessel about its stopping point caused by currents or waves), for which the stopping point may be an anchorage point or area or docking point or area.

Taking into account the schemes mentioned above, some real-life practical examples are now described with reference to particular urban waterways around the world. These examples are intended to be non-limiting on the invention and demonstrate the way in which the abovementioned schemes can be applied to solved the problems described above for any urban waterway.

Examples of Navigation Routes that Satisfy Navigation Problems that are Subject to the Above Constraints

The following examples use the waterways of the San Francisco region to teach and illustrate navigational techniques for the structures, systems and methods disclosed herein for the waterways of any urban region, especially those with anchorages. Routes in the following examples can be programmed into the navigational systems and/or energy management systems, or determined dynamically by the navigational systems and/or energy management systems.

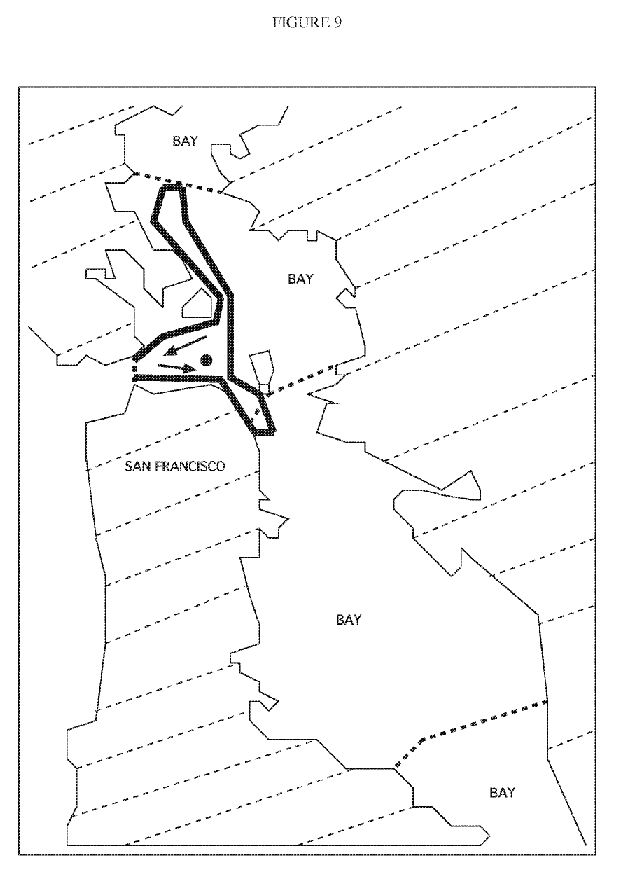

FIG. 8 is a diagram depicting some of the General Anchorage areas of the Bay of San Francisco, areas which are located mostly on the east side of the bay (areas 4, 5, 6, 8, and 9), and a Temporary Anchorage area (area 7) between the northern San Francisco piers and Treasure Island. The routes depicted in FIG. 6, which traverse these general anchorages, can be traveled daily in mostly continual motion at approximately one nautical mile an hour; or can be traveled via a stop-and-go pattern of motion, anchoring in each anchorage for a length of time, before travelling at a higher knot rate to the next anchorage, with the entire range of motion averaging approximately one nautical mile per hour. Routes that are shorter than those depicted in FIG. 6 can be traveled more slowly to save fuel, or traveled multiple times each day, while longer routes can be traveled more rapidly each day, or more slowly for route completion requiring a few days.

One example of a route to be navigated many days of the year is for a NUFORS to remain at anchor, or slowly adrift, in General Anchorage 9 during the late night, approximately from 1 AM to 7 AM, for example, offshore from Hunters Point, approximately at a longitude of 122 degrees, 21 minutes and a latitude of 37 degrees, 44 minutes (a location which provides nice views of the night skylines of San Francisco and Oakland). Then at about 7 AM, the NUFORS starts travelling north, arriving in the waters between San Francisco and Oakland around 9 AM (so that residents can take tenders to connect to transport for work or pleasure), and then is navigated much of the morning and afternoon in and around General Anchorages 4, 5 and 6 (which provides close shuttle access to Berkeley and Treasure Island). Around 5 PM, the NUFORS can be navigated back to the lower part of Anchorage 6, for example, to pick up residents who are returning from their daily land-based activities. Depending on water traffic, the NUFORS can also be navigated in a counter-clockwise loop around Alcatraz Island in the early evening, providing residents with excellent views, and close access to the nightlife of San Francisco (e.g., Fisherman's Wharf, North Beach, Chinatown) via a tender to the northern piers. Afterwards, the NUFORS can be navigated south towards resting points in General Anchorage 9.

Such a daily route satisfies the navigation rules discussed above, while satisfying the logistical constraints of occupants, in particular, periodic transfer to transportation systems on land. The daily route can vary in numerous ways, with a NUFORS in motion and at anchor for different amounts of times at different locations, with all of these routes travelling through the eastern General Anchorages 4, 5, 6, 8 and 9. Relying on a variety of similar daily routes eases the familiarity of local authorities with the travels of a NUFORS, route plans which are typically filed with such authorities.

Similar navigation routes can be designed for a NUFORS in other urban waterways with general anchorage areas. General anchorage areas provide space for more navigational solutions for navigating a NUFORS, which can optionally either be in motion, or be at rest for as long as local laws permit, in such areas. For example, if a NUFORS needs to be navigated across a shipping channel for which there is a cargo ship passing through, the NUFORS can mostly drift in a nearby general anchorage area until the cargo ship has cleared the area.

FIG. 9 is a diagram illustrating a region of the main Regulated Navigation Areas of San Francisco Bay. When a NUFORS is navigated outside of a General Anchorage, it will typically traverse a Regulated Navigational Area, typically narrow sections of the bay where heavy vessel traffic is being navigated to and from offshore locations, for example, cargo ships moving from offshore under the Golden Gate Bridge with a termination at the piers at Oakland Harbor. For example, for the Bay of Francisco, the Captain of the Port has designated all major deep draft ship channels as narrow channels or fairways, with some channels designated as Regulated Navigation Areas to help organize traffic patterns. (See “Rule 9 . . . A Rule to Live By”, http://www.uscg.mil/d11/vtssf/rule9.asp). In these areas, smaller vessels should avoid impeding larger vessels under the terms of Colregs Rule 9. Larger vessels are given deference due to their need for more time and space to maneuver to avoid collision.

A NUFORS can satisfy Rule 9 regulations, for example, by having the pilot and/or navigation system obtain schedules of heavy vessel traffic in waterways such as the San Francisco Bay (or the waterways of Puget Sound or Chesapeake Bay, etc.), and arrange navigational routes that avoid Regulated Navigation Areas when there is scheduled traffic. Also, fuel that is saved while a NUFORS is at anchor or slowly moving in an anchorage area can be used to propel the vessel at a higher speed while it is moving in, or crossing through, a Regulated Navigation Area, to facilitate design of navigational routes that avoid collisions.

### Examples of Daily Navigation Routes

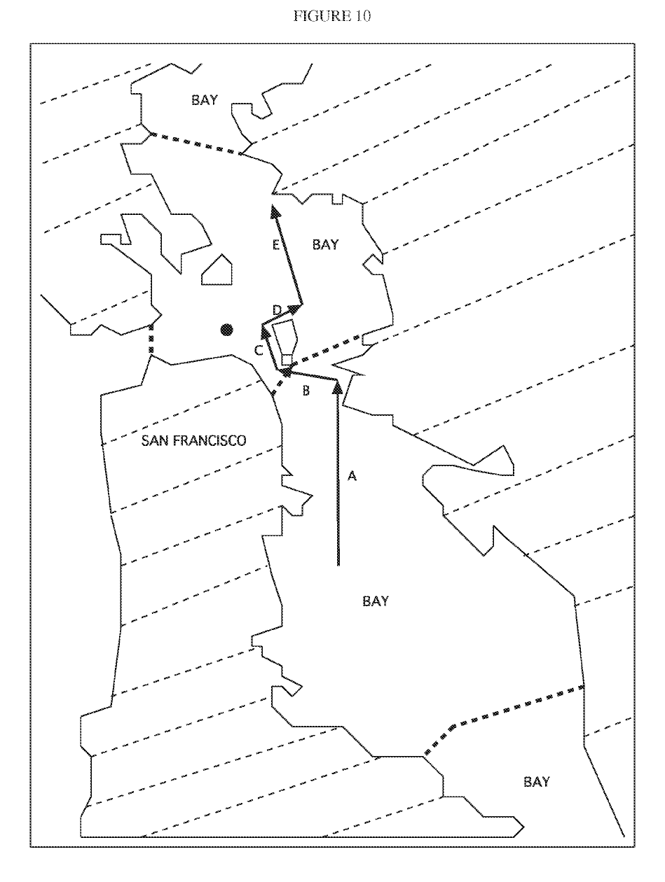

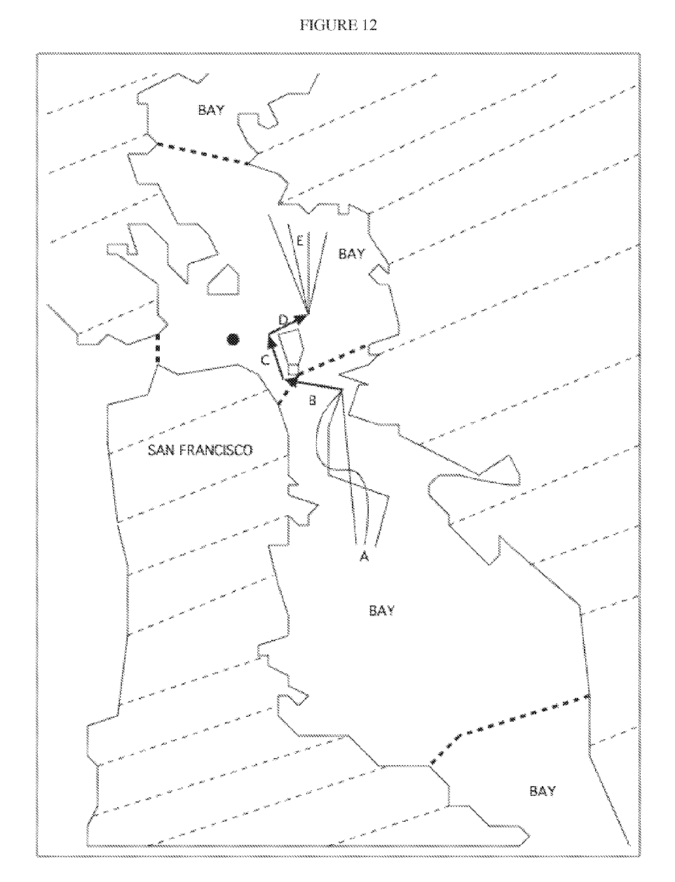

FIG. 10 is an example of a daily navigational route with five segments for a NUFORS that satisfies the navigational constraints described above, comprising linear segments A, B, C, D, and E. All times and coordinates used below are approximate. For example, a route segment that starts at 8 AM and ends at 9 AM can easily start at 8:10 AM and end at 8:55 AM by having the NUFORS navigated at a faster speed. Or a mostly due north segment can be replaced by a slightly longer route that can be mostly 30 seconds of longitude east or west or the original segment. FIG. 12 depicts some such varied routes. The route segments in FIGS. 10, 11 and 12 are depicted as straight lines only for illustration purposes. For example, the five straight segments A to E in FIG. 10 can be replaced by one smooth curve, or a combination of curves and lines.

For one example of a daily route, a NUFORS is located at the beginning of segment A (east of South San Francisco) centered at coordinates of latitude 37 degrees, 41.75 minutes, north; and longitude 122 degrees, 20.50 minutes, west; with the NUFORS at this location at approximately midnight. Segment A can be mostly located inside General Anchorage 9. Over the next six hours, the NUFORS can be navigated mostly due north, arriving at the end of segment A (and beginning of segment B) around 6 AM, if the NUFORS travels the six nautical mile distance at an average rate of one knot. The NUFORS can also start at another location in General Anchorage 9, if from that location, the NUFORS can be in the vicinity of the beginning of Segment B around 6 AM. Indeed, the NUFORS can anchor near the end of segment A for the entire time between 12 AM and 6 AM.

Approximately from 6 AM to 8 AM, the NUFORS can be navigated along segment B, a distance of approximately 1.75 nautical miles, arriving at the end of segment B (and beginning of segment C) around 8 AM, roughly moving at a rate of 0.90 knots. The beginning of segment B can be centered at coordinates of latitude 37 degrees, 47.75 minutes, north; and longitude 122 degrees, 20.50 minutes, west. Segment B can be mostly located inside General Anchorage 8. Segment B can also be located approximately three kilometers from the Port of Oakland, allowing residents to be transported to the Port using a tender to connect to the East Bay regional transportation system, for those residents that work or go to school or relax in the East Bay.

Approximately from 8 AM to 9 AM, the NUFORS can be navigated along segment C, a distance of approximately one nautical mile, arriving at the end of segment C (and beginning of segment D) at 9 AM, roughly traveling at a rate of one knot. The beginning of segment C can be centered at coordinates of latitude 37 degrees, 48.50 minutes, north; and longitude 122 degrees, 22.50 minutes, west. Segment C can be mostly located inside Temporary Anchorage 7. Segment C can also be located less than one kilometer from the northern piers of San Francisco (including the Ferry Building), allowing residents to be transported to the piers via a tender to connect to the San Francisco regional transportation system, for those residents that work or go to school or relax in San Francisco (and/or points south along the peninsula).

Navigation strategies combining general anchorage areas (e.g., in which Segment A can be located in the Bay of San Francisco), which can be proximate to regulated navigation areas (e.g., in which Segments B and C can be located in the Bay of San Francisco Bay) that can also be proximate to land-based transportation portals (e.g., the piers near the Ferry Building in San Francisco), can be navigation strategies used to navigate a NUFORS in other urban waterways, including navigation strategies that keep the NUFORS closer to one area of land-based portals (for example, in San Francisco Bay, closer to the piers nearby the Ferry Building) to minimize intermodal transport times. Once these combinations are determined, segmented navigational routes can be specified that can be traversed at speeds/daily-distances approximately equal to one knot/24 nautical miles (or faster/longer if more fuel is used, or slower/shorter if less fuel is used). In the United States, the United States Coast Pilot series available at www.nauticalcharts.noaa.gov/nsd/cpdownload.htm provide coordinates for, and regulations for using, anchorage areas in the United States.

Segments B and C pose more navigational constraints, since when a NUFORS is traversing these segments, the route of the NUFORS can intersect active shipping channels at times of the day when there is regularly scheduled traffic, such as ferries and cargo ships. Fuel saved when a NUFORS is drifting in other segments (such as Segments A and E) can be used to propel the NUFORS at a higher speed, if needed, to avoid other traffic while in Segments B and C. This method of fuel allocation and varying speed can be used when navigating a NUFORS across an active shipping channel in other urban waterways.

Approximately from 9 AM to 10 AM, the NUFORS can be navigated along segment D, a distance of approximately 1.09 nautical miles, arriving at the end of segment D (and beginning of segment E) at LOAM, roughly traveling at a rate of one knot. The beginning of segment D can be centered at coordinates of latitude 37 degrees, 49 minutes, 27 seconds, north; and longitude 122 degrees, 22 minutes, 54 seconds, west. Segment D can end inside General Anchorage 6. Segment D can be far from the northern piers of San Francisco, but still reasonably reachable by a tender. Segment D can be approximately three kilometers from the Berkeley piers, allowing the residents of a NUFORS to be transported to the piers via a tender to connect to the East Bay transportation system.

Approximately from 10 AM to 1 PM, the NUFORS can be navigated along segment E, a distance of approximately 3.89 nautical miles, arriving at the end of segment E (and beginning of the return navigational route) at 1 PM, roughly traveling at a rate of 1.3 knots. The beginning of segment E can be centered at coordinates of latitude 37 degrees, 50 minutes, 12 seconds, north; and longitude 122 degrees, 21 minutes, 54 seconds, west. The end of segment E can be centered at coordinates of latitude 37 degrees, 54 minutes, north; and longitude 122 degrees, 23 minutes, west. Segment E can be mostly located inside General Anchorage 6, starting approximately in the southern side of the Anchorage and ending approximately in the northern side. Navigational routes for Segment E can be quite varied, as long as at the end of travel in Segment E, the NUFORS is approximately near the location of Segment D, so that the NUFORS can start a southern journey near the end of the workday to travel approximately nearby ports and piers to transfer NUFORS residents.

The second 12 hours of daily navigation for the NUFORS can be approximately the same segment order in reverse. The NUFORS travels segment E from approximately 1 PM to 4 PM, segment D from approximately 4 PM to 5 PM, segment C from approximately 5 PM to 6 PM (and thus in a convenient location to pick up residents returning from work, school or play in San Francisco), segment B from approximately 6 PM to 8 PM (and thus in convenient location to pick-up residents returning from work, school or play in the East Bay), and segment A from approximately 8 PM to 12 AM.

Routes similar to that depicted in FIG. 10 allows a NUFORS to mostly travel at a rate of one knot, minimizing economic constraints on fuel consumption. The NUFORS can also be navigated through anchorage areas that allow the NUFORS to temporarily slow down to drift rates to save fuel, using the saved fuel to later cross Regulated Navigational Areas/shipping lanes at much higher rates (many knots) to avoid any other traffic such as cargo ships or ferries, and thus satisfy all regional navigational rules. A route for a NUFORS can be timed to be located approximately adjacent to land-based transportation portals (e.g., for the Bay of San Francisco, near the San Francisco piers and Port of Oakland) so that occupants can easily transfer back and forth to the NUFORS via a tender at times coordinated to their work, educational or entertainment needs.

The exemplary route specified above is mostly a route that, in early mornings and evenings, can have a NUFORS located offshore of South San Francisco (with southern views of San Francisco and Oakland, views of the hills of the San Francisco and of the East Bay hills that are south of Oakland, and views of the Oakland and San Francisco airports), a route that, in the late mornings and afternoons, can have the NUFORS located west of Berkeley (with northern views of San Francisco and Oakland, views of the main Bay islands, and views of the Marin headlands).

These route locations can be reversed, with a NUFORS located offshore of South San Francisco in the late mornings and afternoons, and west of Berkeley in the early mornings and afternoons. For such positioning, the NUFORS can approximately traverse Segment E from 12 AM to 6 AM, Segment D from 6 AM to 7 AM, Segment C from 7 AM to 8 AM, Segment B from 8 AM to 10 AM and segment A from 10 AM to 12 PM. In reverse, the NUFORS can traverse segment A from 12 PM to 3 PM, Segment B from 3 PM to 5 PM, Segment C from 5 PM to 6 PM, Segment D from 6 PM to 7 PM, and Segment E from 7 PM to 12 AM.

The route for any one segment can be varied in numerous different ways, as long as the daily transfers between a NUFORS and the land satisfy the timing needs of residences. For example, FIG. 12 shows a plurality of different routes for Segments A and E, as variants of the routes for Segments A and E in FIG. 10. Where routes in FIG. 12 are shorter or longer than those in FIG. 10, the speed of the NUFORS can be adjusted to satisfy any timing constraints for NUFORS-to-land transfers.

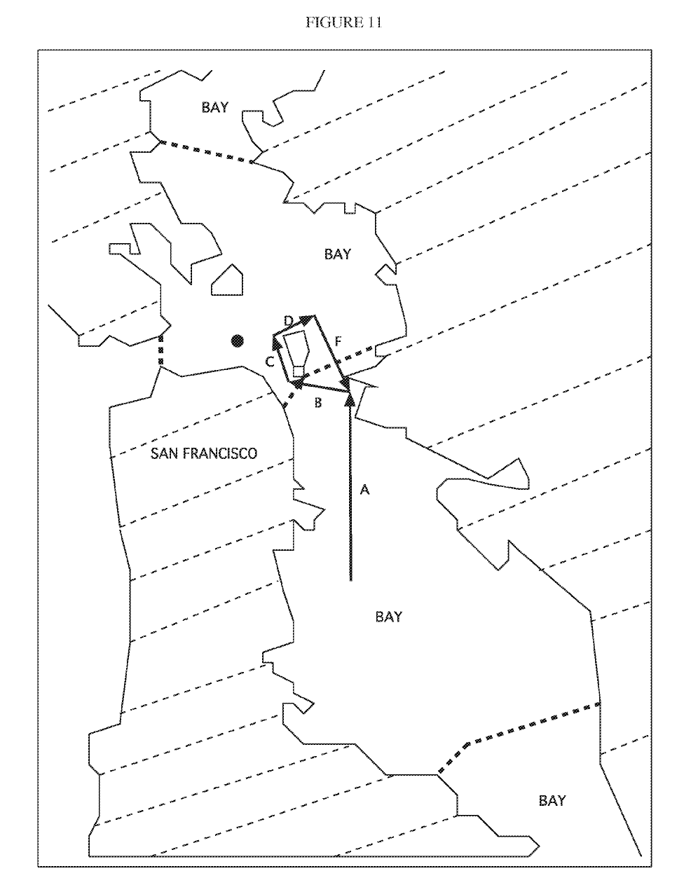

Exemplary routes specified above have a NUFORS being navigated at least a few hours along both segments A and E, travelling west and south of Treasure Island during segments B and C to facilitate transfer of residents of the NUFORS to/from land-based transportation portals. Optionally, a NUFORS can be navigated in a loop around Treasure Island to traverse either Segment A or Segment E each day (and thus located north of San Francisco and Oakland most of the day, or located south of San Francisco and Oakland most of the day). For example, to mostly avoid Segment A, the NUFORS can approximately traverse Segment E from 12 AM to 6 AM, Segment D from 6 AM to 7 AM, Segment C from 7 AM to 8 AM, Segment B from 8 AM to 10 AM, and then be navigated east and north of Treasure Island (Segment F in FIG. 11) to a location in General Anchorage 6 near either Segment E or Segment D, being navigated and/or drifting through General Anchorage 6 from approximately 10 AM to 4 PM. From approximately 4 PM to 5 PM, the NUFORS traverses segment D, and approximately from 5 PM to 8 PM traverses Segments C and B which are nearby the ports and piers of San Francisco and Oakland. Starting approximately at 8 PM, the NUFORS again can be navigated east and north of Treasure Island, ending in General Anchorage 6 to be located during the evening north of San Francisco and Oakland, and then be navigated to be traversing Segment D approximately from 6 AM to 7 AM the next morning, thereby for the most part never being navigated in the vicinity of Segment A. The segment traversal for this more northern route, in short form, is [Segments: E, D, C, B, F, D, C, B, F, E]. A segment traversal for a more southern route, in short form, is [Segments: A, B, C, D, F, B, C, D, F, A], for the segments depicted in FIG. 11.

Another exemplary system can be to have one NUFORS travel the more northern route, while another NUFORS travels the more southern route. Additionally, multiple NUFORSs can be navigated along the same sequence of Segments, as long as they are separated in time and distance according to local navigation rules. For example, nearby New York City, one NUFORS during one half of the day can be navigated north up the Hudson River, while a second NUFORS during the same half of the day can be navigated south.

A similar navigational route can be established so that a NUFORS rarely is navigated in the vicinity of Segment C, that is, navigating the NUFORS east and north of Treasure Island to directly connect Segments B and D. For either such route, a NUFORS can be navigated solely east/north of Treasure Island (for example, traversing, in order, [Segments: E, D, B, B, D, E]). Navigating east/north of Treasure Island has the advantage of not requiring the NUFORS to cross shipping channels such as are present in Segment C (though for some years 2010 onwards, there is a navigational constraint north/east of Treasure Island due to the reconstruction of the East Bay bridge).

By navigating a NUFORS along these exemplary routes, occupants of the NUFORS can be provided convenient access to land portals to travel to any of a variety of locations for purposes such as education, work, shopping, entertainment, etc. Such navigational routes also allow one or more residences on a NUFORS to be used as a floating office. While the above examples to navigate a NUFORS along segments B and C to provide residents access to land-based portals approximately at the beginning and end of each work day, navigation along such segments can also provide workers access to an office on the NUFORS, also approximately at the beginning and end of the day (with a tender used to transport workers to and from the NUFORS at random times during the day).

By locating a NUFORS for more hours each day in the general anchorage areas of urban waterways, such as in the vicinity of either Segment A or Segment E, fuel can be saved to navigate the NUFORS to more distant locations in such waterways, for example, the northern or southern parts of San Francisco Bay. For example, consider the case where a NUFORS is located mostly about Segment E between Berkeley and Marin county. In this case, the NUFORS optionally can be navigated north to under the Richmond San Rafael bridge into the San Pablo Bay, with its views of the hills of northern East Bay county and southern Sonoma county. Another such option can be to navigate a NUFORS west towards the Golden Gate Bridge north of Alcatraz Island and then back east south of Alcatraz Island, returning to General Anchorage 6 in the vicinity of Segments E and D. This latter route, while providing some of the most beautiful views of the San Francisco Bay, also crosses more shipping channels, and thus needs extra fuel to propel the NUFORS at higher speeds, when necessary, to avoid any other (larger) vessel traffic.

Two or more NUFORSs can share the same route (separated in time or distance according to vessel regulations). For example, two NUFORSs can be separated by a few hundred yards as they are navigated along a similar route on the Hudson River between Manhattan and New Jersey.

In those urban regions where two or more NUFORSs are used, one or more tenders can be shared to transport occupants to/from a NUFORS to land-based portals. These tenders can belong to a NUFORS, or be associated with a transportation service based on land (for example, Baydelta Maritime located at Pier 15 in San Francisco). Such use of tenders allow a NUFORS to be navigated for less time near land portals (which can be close to more trafficked shipping channels), with the extra distance to be covered by tenders.

6.6.9 NUFORS Navigation that Minimizes Use of Energy, Water, and Waste Disposal

One major logistic advantage of residential housing or office space on land is the simplicity of supplying the main utility needs of oil, electricity and water, typically provided through pipes or conduits that are underground. Indeed, a majority of traditional houseboats generally are fixed in place, with no navigation needs, because the houseboats rely on the same type of physical connections to utilities as do buildings on land. For buildings on land, residential or office, it is also relatively easy to remove wastes, for example, by putting physical wastes in containers that are outside the building for collection by public or private waste disposal services, or by using pipes and conduits to transport wastes that are mostly fluid to public water treatment facilities. All that is needed is to physically connect the building to local utility infrastructures.

Because a NUFORS can be unable to regularly acquire and dispose of utility-based resources through physical connections that are mostly constant, the NUFORS can make periodic connections to land-portals as described above, either mooring and/or using a tender. One way to minimize the frequency of such transfers and the volume of resources transferred to and from a NUFORS can be to acquire and dispose of such resources onboard the NUFORS.

Waste disposal can be minimized by using environmentally-friendly waste technologies (e.g., volume minimizing toilets, and filtering systems for shower water). For example, Sancor Industries sells the Envirolet Waterless Composting toilet system, a mostly waterless toilet system that uses minimal amounts of water and requires minimal amounts of storage for the composted wastes. Similar technology can be used for treatment of wastewater from showers and sinks. Compacting machines can be used to minimize the amount of space needed to store other wastes such as glass/plastic containers, etc.

### 6.6.10 Navigation System and Energy Management System Control

The navigation system of a NUFORS can be programmed with daily, weekly and monthly navigation routes based on the above constraints, routes which can be used manually by one of more human pilots, and/or by automated navigation control systems (e.g., an autopilot). Any random incidents can be handled with reprogramming of routes. The navigation system either can interface with electronic controls of one or more onboard engines to control movement of the NUFORS, or can interface with the navigational system of a second vessel (e.g., a tugboat) that is pushing or pulling a NUFORS.

A variety of electronic navigation systems can be used to navigate a NUFORS, for example, systems incorporating technology found in U.S. Pat. No. 6,826,478 (“Inertial navigation system for mobile objects with constraints”), U.S. Pat. No. 6,708,113 (“Navigation method for a means of transport”), U.S. Pat. No. 6,567,743 (“Method and device for determining a route from a starting location to a final destination”), U.S. Pat. No. 5,969,665 (“Method and apparatus for control of vessel maneuvering”), U.S. Pat. No. 5,633,644 (“Processing for monitoring ship traffic at sea while recognizing oil spills and potential ship collisions”), U.S. Pat. No. 5,515,287 (“Navigation display apparatus for collision avoidance utilizing polygonal safety regions and predicted danger areas”), and U.S. Pat. No. 5,191,341 (“System for sea navigation or traffic control/assistance”).

Standardized software packages, and/or their circuit equivalents, can be used as part of the navigation system for a NUFORS. For example, VNS MAX Pro (www.nobeltec.com) is a visual navigation system that includes the following properties: real time vessel positioning, quilting for seamless chart integration, distance and bearing to active mark/route/target, unlimited route and waypoint placement, GPS upload/download, auto-pilot support and other features. Garmin Ltd. (www.garmin.com), and Sperry Marine, offer, a variety of hardware and software systems for marine radar, traffic monitoring, autopiloting, sonar and other navigation-related equipment that can be used as part of the navigation system for a NUFORS. Such navigation systems easily accept navigational routes (e.g., through anchorage areas) specified at least as sets of times and geographical coordinates.

A variety of daily navigational routes are disclosed herein as examples, typically as sets of latitude and longitude coordinates; or sets of latitude and longitude coordinates and start/stop or duration times. Such exemplary coordinates and exemplary time points are approximate. For example, if a section of a navigational route starts at 12 PM, the section can be started at 12:05 PM with the vessel being navigated slightly faster to reach the next section around its starting time. Computer programs, such as GPSBabel (www.gpsbabel.org), can be used to convert the latitude/longitude/timing information, for the navigation routes disclosed herein, into data files that can be used by a plurality of commercial navigation and autopilot systems. GPX (the GPS Exchange Format) also can be used to represent the latitude/longitude/timing information disclosed herein, for interchange between navigational systems.

The energy management system for a NUFORS can either be a separate hardware/software apparatus that exchanges navigational information with the navigation system, or the energy management system can be a sub-system within the navigation system. In both cases, for example, the energy management system can comprise one or more computer programs and databases that use information about time, location and fuel status provided by the navigation system to determine navigational routes use minimal energy, routes that are communicated to the navigation system.

Further, such a navigational system and/or energy management system can include, or be implemented by, one or more computing systems, which can, in turn, include, for example, a processor, memory, storage, and input/output devices (e.g., monitor, keyboard, disk drive, Internet connection, etc.) Such computing system(s) can include circuitry or other specialized hardware for carrying out some or all aspects of the processes. In some operational settings, computing system(s) may be configured as a system that includes one or more units, each of which is configured to carry out some aspects of the processes in either software, hardware, or some combinations of the two.

Additionally, a media that can be read by a computer also can be used to store (e.g., tangibly embody) one or more computer programs for performing any one of the above-described processes by means of a computer. The one or more computer programs may be written, for example, in a general-purpose programming language (e.g., C, Java, Ada, Lisp) or some specialized application-specific language. The one or more computer programs may be compiled for execution on a processor, or for being loaded into programmable hardware devices such as field programmable gate arrays (FPGAs) or application specific integrated circuits (ASICs).

### 6.7 Other Exemplary Aspects

NUFORS Navigation to Assist Homeland Security:

Urban waterways, such as San Francisco Bay, can be strategic centers for security for their countries, and as such, can require extra surveillance activity. A NUFORS can provide a slow-moving platform for a sensor platform for providing regular coverage of traffic in the region. As a (for-fee) service to security agencies, such as coast guards, one or more sensor packages (e.g., day and night vision cameras, radar, radiation sensors) can be placed aboard the NUFORS, with the gathered data securely transmitted to local security agencies. Such cameras can also send signals to commercial security monitoring companies. A coast guard agency can rent an office on a NUFORS.

NUFORS Used as Setting for Reality Television:

The novelty of a NUFORS, and the novelty of a lifestyle of living in a residence that is navigated in an urban region, has new and useful entertainment value, as a NUFORS has never been used as a plot element in a television show, movie or advertisement. The entertainment uses of a NUFORS include being used as a setting for reality television shows, similar to the Real World, which has used land-based residences in cities such as San Francisco, New York, Seattle and Sydney, all of which have waterways in which to use to the methods and systems disclosed herein. For example, “Floating World—SFBay” can feature a group of young, naval architects living together while competing to design NUFORS vessels and residences during the day, and partying in the city at night.

### 7. SPECIFICATIONS FOR OTHER URBAN REGIONS

The above description of the embodiments, alternative embodiments, and specific examples, using the region of San Francisco Bay, are given as examples and should not be viewed as limiting. What follows are similar exemplary descriptions for three other urban regions around the world: Rio de Janeiro, Lisbon, Sydney and Tokyo.

### 7.1 Baia de Guanabara/Rio de Janeiro

Characteristics of Baia de Guanabara as an urban region are the adjacent city/cities including Rio de Janeiro and Niteroi; where the adjacent ocean is the Atlantic Ocean; where the (natural) isolating barriers are the hills of Rio de Janeiro and Niteroi; where the two-dimensional navigational routes include in/out-bound ocean traffic in front of the Rio-Niteroi Bridge to the Rio port along the waterfront from North Centro thru Sao Cristovao to Caju, ferry traffic between Rio de Janeiro and Niteroi, as well as recreational and fishing vessels crisscrossing the Bay; and where there are ample resources and opportunities, including social (e.g., in Ipanema, Copacabana, Botofago, Flamengo, etc.); medical (e.g., Hospital Copa d'Or), educational (e.g., Universidade Federal do Rio de Janeiro), occupational (e.g., the Centro business, etc.); entertainment (e.g., along Avenida Atlantica in Copacabana); transportation (e.g., City Busmove, Frescao executive bus, and the Rio subway); and telecommunications (e.g., the many landline, wireless, cable and Internet systems that are commercially available from companies such as Embratel and Oi).

One example of a daily route is for a NUFORS to remain anchored, or slowly adrift, in the northern part of Baia de Guanabara starting around midnight. Then at about 7 AM, the NUFORS starts travelling south, in the waters offshore of the Rio port waterfront (a short distance to transport residences to land transportation portals), and then is located much of the morning and afternoon navigating in and around that part of the Baia off of the Urca area of Rio, and where ocean surface conditions are clement, as far south as being off the beaches of Copacabana and Ipanema. Around 5 PM, the NUFORS can be navigated back to the waters that are offshore the Rio port, to pick up residents returning from their daily activities on land. Depending on water traffic and near-shore ocean conditions, the NUFORS can be navigated back up into the northern part of the Baia; or offshore close to the beaches and nightlife of Ipanema, Copacabana, Botofago, and Flamengo, before heading back to the northern Baia area.

### 7.2 Tagus (Tejo) Bay/Lisbon

Characteristics of Tagus (Tejo) Bay as an urban region are the adjacent city/cities including Lisbon and Almada; where the adjacent ocean is the Atlantic Ocean; where the (natural) isolating barriers are the hills of Lisbon and the peninsula south of Almada; where the two-dimensional navigational routes include in/out-bound ocean traffic under the Ponte 25 de Abril bridge to the Lisbon port along the waterfront from Alges to Alfama, ferry traffic between Lisbon and Trafaria, Porto Brandao, Cacilbas, Seixal and Barreiro, as well as recreational and fishing vessels crisscrossing the Bay; and where there are ample resources and opportunities, including social (e.g., in Alfama, Bairro Alto, Baixa, Belem, etc.); medical (e.g., Hospitais Civis de Lisboa), educational (e.g., Universidade de Lisboa), occupational (e.g., the central business district near Sete Rios and Praca de Espanha, etc.); entertainment (e.g., in Bairro Alto and Doca de Alcantara); transportation (e.g., Metropolitano de Lisboa and Carris, ferries out of the Cais do Sodre ferry terminal); and telecommunications (e.g., the many landline, wireless, cable and Internet systems from that are commercially available from companies such as Portugal Telecom and Vodafone Portugal). One more similarity with San Francisco is that the main bridge of Lisbon, the Ponte 25 de Abril, has long been noted for its visual similarity to Golden Gate Bridge in San Francisco.

One example of a daily route is for a NUFORS to remain anchored, or slowly adrift, in the waters mostly east of central Lisbon and mostly above Barreiro (for example, at a latitude of 38.71 degrees north and -9.07 degrees east and related locations about 6 miles northeast of the Ponte 25 de Abril) starting around midnight. Then at about 7 AM, the NUFORS starts travelling west, in the waters offshore of the Lisbon waterfront (e.g., using tenders to transport residents to piers that are nearby public transportation), and then is located much of the morning and afternoon navigating west of the Ponte 25 de Abril offshore of Oeiras, approximately 6 miles west of the Ponte 25 de Abril around the noontime (a distance of approximately 12 nautical miles from midnight to noon, at an average speed of approximately one nautical mile an hour, much like the average speeds used in some of the examples for navigation in the Bay of San Francisco). Around 5 PM, the NUFORS can be navigated back to the waters that are offshore the Lisbon port, to pick up residents returning from their daily land-based activities. Depending on water traffic and near-shore ocean conditions, the NUFORS can be navigated further east to the beaches areas of Cascais and Estoril, or further northeast of Lisbon in the waters around the Ponte Vasco de Gama.

### 7.3 Sydney Harbor/Sydney

Characteristics of Sydney Harbour as an urban region are the adjacent city/cities including Sydney and North Sydney; where the adjacent ocean is the Pacific Ocean; where the (natural) isolating barriers include the Vaucluse peninsula; where the two-dimensional navigational routes include shipping traffic on either side of the Sydney Harbour Bridge, ferry traffic from Sydney Ferries' hub at Circular Quay to destinations such as Parramatta, Manly and Watsons Bay, as well as recreational and fishing vessels crisscrossing the Bay; and where there are ample resources and opportunities, including social (e.g., restaurants, clubs and museums throughout Circular Quay, City Centre, Darling Harbour, Kings Cross and Darlinghurst, etc.); medical (e.g., Sydney Hospital), educational (e.g., University of Sydney), occupational (e.g., the central business district south of Sydney Cove, etc.); entertainment (e.g., the entertainment district in Darling Harbour, etc.); transportation (e.g., Sydney Buses, CityRail and Metro Light Rail); and telecommunications (e.g., the many landline, wireless, cable and Internet systems that are commercially available from companies such as Sydney Telecommunications, Macquarie Telecom, Vodafone Pacific, etc.).

One example of a daily route is for a NUFORS to remain anchored, or slowly adrift, in the northern part of Sydney Harbour (for example, in the waters between Watsons Bay and Georges Heights) starting around midnight. Then at about 4 AM, the NUFORS starts travelling towards the Sydney Harbour bridge, arriving around 8 AM to 9 AM in the waters offshore of The Rocks and Circular Quay (a short distance to transport residences to land transportation portals). During the rest of the morning and afternoon, the NUFORS can either be navigated back to the northern part of the bay, or can pass underneath the Sydney Harbour bridge to travel in the inner harbour. Around 4 PM, the NUFORS can be navigated back to the waters that are offshore downtown Sydney, to pick up residents returning from their daily activities on land.

### 7.4 Tokyo Bay/Tokyo

Characteristics of Tokyo Bay as an urban region are the adjacent city/cities including Tokyo, Kawasaki and Chiba; where the adjacent ocean is the Pacific Ocean; where the (natural) isolating barriers include the Boso peninsula; where the two-dimensional navigational routes include shipping traffic on either side of the Trans-Tokyo Bay Highway, ferry traffic within the Bay (for example, to Chiba, Kawasaki or Yokosuka) and further (for example, to Kyushu), as well as recreational and fishing vessels crisscrossing the Bay; and where there are ample resources and opportunities, including social (e.g., restaurants, clubs and museums throughout Meguro, Taito/Ueno and Shinjuku districts (-ku), etc.); medical (e.g., Sanno Hospital), educational (e.g., University of Tokyo), occupational (e.g., the business districts in Nihombashi, Marunouchi and Shinjuku) entertainment (e.g., the entertainment areas in Akasaka, Ginza, Roppongi, Shibuya, etc.); transportation (e.g., Tokyo Metro, Japan Railway, the Toei buses, etc.); and telecommunications (e.g., the many landline, wireless, cable and Internet systems that are commercially available from companies such as NTT, KDDI and Softbank, etc.).

One example of a daily route is for a NUFORS to remain anchored, or slowly adrift, in the northern part of Tokyo Bay (for example, in the waters south of Koto-ku and Edogawa-ku) starting around midnight. Then at about 4 AM, the NUFORS starts travelling towards the Port of Tokyo, arriving around 8 AM to 9 AM in the waters offshore of Odaiba Island. During the rest of the morning and afternoon, the NUFORS can either be navigated back to the northern part of the bay (south of Koto-ku and Edogawa-ku), or can head towards the Trans-Tokyo bridge to travel towards the southern part of the harbour. Around 4 PM, the NUFORS can be navigated back to the waters that are offshore of Odaiba Island, to pick up residents returning from their daily activities on land.

### 8. OTHER EMBODIMENTS

Optimization of Intermodal Transport—

For some people using a NUFORS, the occasional or scheduled transport to shore, for example, once or twice a day, will be sufficient, for example to go to work or school, to return home, or to go to social events. With a variety of tenders, and navigational routes, for example, as disclosed in FIGS. 10, 11 and 12, such occasional or scheduled transport needs can be satisfied.

However, for other people using a NUFORS, transport that is more frequent or unscheduled, with shorter transport times, will be preferred. For example, a business using part of a NUFORS as an office, might want to transport clients to and from the NUFORS many times throughout a weekday. Or, for example, a family living on part of a NUFORS will, on weekends want to transport themselves multiple random times to and from the NUFORS to meet with friends, go shopping/dining, attend a medical appointment, etc.

To satisfy more frequent intermodal transport needs, other navigational routes can be generated that locate a NUFORS closer to onshore areas of an urban region. For example, consider the Bay of San Francisco. FIG. 10, discussed above, shows a navigational route that allows residents of a NUFORS to regularly make use of both sides of the bay, both San Francisco and East Bay, at the expense of greater inter-modal transport times to one side of the bay when the NUFORS is closer to the other side of the bay.

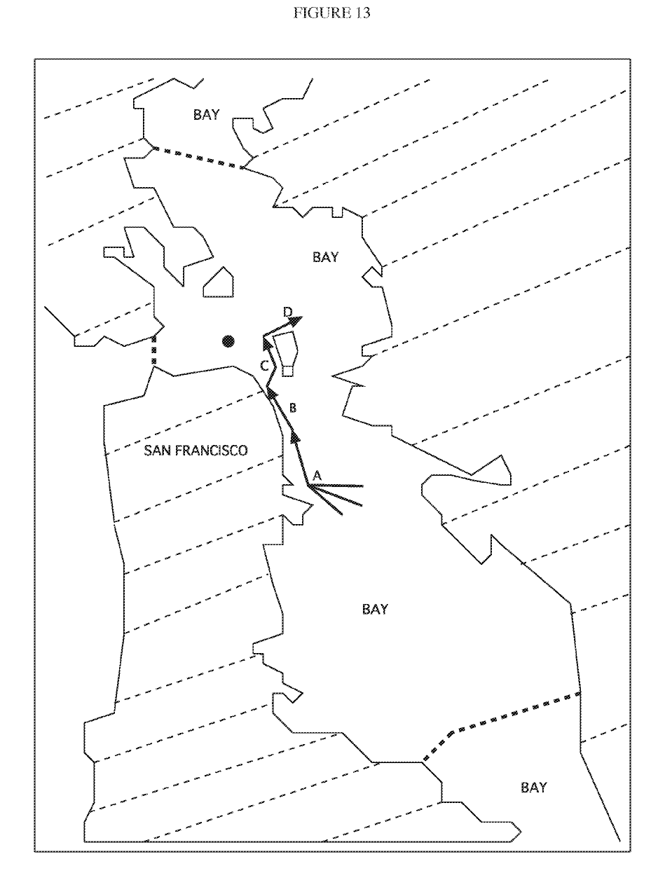

However, for those using a NUFORS such that they travel mostly to one side of the bay (e.g., the city of San Francisco), there are many navigational routes that can be used to navigate a NUFORS that provide more opportunities for intermodal transport with shorter transit times. For example, consider FIG. 13, a variant of FIG. 10, where the navigational route mostly is close to the San Francisco side of the bay. The beginning and ending of a day can have the NUFORS located in the vicinity of the navigation routes of Segment A, adrift in the northern end of General Anchorage 9. In the early morning, heads north to navigate segments B, C and D during the day.

For many locations on segments B, C and D, a NUFORS will be less than a few nautical miles away from land portals, such as Pier 38 and the Ferry Building. Using a tender, such as a Minor Offshore 25 (MO25) cruiser, residents of the NUFORS can be transported in ten to five minutes at many random times throughout the day. The MO25 is a sturdy boat, with comfortable seating room for four, and good fuel consumption (2.3 gallons at 6.7 knots, and 8.7 gallons at 24 knots).

For all locations on the navigational route depicted in FIG. 13 that are approximately one nautical mile from a pier, the MO25 can transport residents in about ten minutes (similar to waiting times for a cab in San Francisco) while using about half a gallon of fuel (approximately $2, compared to $3 for the first fifth of a mile transport in a taxi in San Francisco). For navigational routes with greater range, such as FIG. 10, where the NUFORS can be about four nautical miles from the piers of San Francisco, residents of the NUFORS can be transported to a pier in the same ten minutes while traveling at 24 knots, while using about 1.5 gallons of fuel (approximately $6, similar to the cost of a taxi ride for two miles in San Francisco). Temporarily docking a NUFORS at a pier, such as Pier 38 allows residents to instantly move from/to the NUFORS to/from the land (e.g., docking at Pier 38 for less than four hours during the day can cost 1/foot, while costing $2/foot for an overnight berth).

Minimal Navigation of a NUFORS in Anchorage Areas—

Consider, for example, a location on the waters of San Francisco Bay at coordinates latitude 37 degrees, 49 minutes, north; and longitude 122 degrees, 23 minutes, west, located inside Temporary Anchorage Area 7. This location has a variety of favorable characteristics for mostly permanently locating a NUFORS, in particular, its views (the skyline of San Francisco, the greenery of Yerba Buena Island, with Marin and Oakland in the distance), while being no more than a few nautical miles from most of the piers of San Francisco (a ride of ten minutes at reasonable powerboat speeds of 6 knots). While anchorage areas can be used for anchoring for extended period of times, they usually aren't meant for permanent anchorage—otherwise the first person to anchor a NUFORS in any one location in an anchorage would effectively obtain legal title to that location (until, possibly, such times as urban waterways are crowded with NUFORSes, when additional governmental regulation may be imposed). For that reason, a variety of methods and systems are disclosed herein to navigate a NUFORS through one or more anchorages in an urban region while only temporarily at anchor, or passing though, any one location in an anchorage area.

However, in some waterways, very long term use of a small area in an anchorage is permitted. In such cases where such long term anchorage is permitted, the NUFORS can mostly remain at rest in that small area, except, for example, for occasional movement to facilitate intermodal transport, or for movement for entertainment or relaxation purposes (e.g., to view the sun setting under the Golden Gate bridge by moving from one of the anchorage areas in the Bay to a location directly due west of the Bridge off of the northern waterfronts of San Francisco).

### 9. CONCLUSION

The above description of the embodiments, alternative embodiments, and specific examples, is given by way of illustration and is not intended to be limited to the specific forms set forth herein. Additionally, although a feature may appear to be described in connection with a particular embodiment, a person skilled in the technology will recognize that various features of the described embodiments can be combined in accordance with the invention. Moreover, aspects of the invention described in connection with an embodiment may stand alone as an invention. Moreover, it will be appreciated that various modifications and alterations can be made by those skilled in the technology without departing from the spirit and scope of the invention. The invention is not to be limited by the foregoing illustrative details and embodiments shown, but should be accorded the widest scope consistent with the claims along with their full scope of equivalents.

1-4. (canceled)

5: A floating vessel with multiple residences, comprising:
a) at least one navigation system programmed to control movement of the floating vessel along a navigational route through a waterway, wherein the navigational route passes through at least one anchorage area of the waterway; and
b) at least two residential structures supported by the floating vessel, wherein the navigation system is operable to modify the navigational route through the waterway based on requests from occupants of either of the at least two residential structures, and wherein modifying the navigational route includes one or more of routing the floating vessel away from the navigational route or altering the speed of the floating vessel according to the navigational route.

6: A floating vessel with multiple offices, comprising:
a) at least one navigation system programmed to control movement of the floating vessel along a navigational route through a waterway, wherein the navigational route passes through at least one anchorage area of the waterway; and
b) at least two office structures supported by the floating vessel, wherein the navigation system is operable to modify the navigational route through the waterway based on requests from occupants of either of the offices, and wherein modifying the navigational route includes one or more of routing the floating vessel away from the navigational route or altering the speed of the floating vessel according to the navigational route.
